(19) United States
(12) Patent Application Publication
(10) Pub. No.: US 2003/0036374 A1
(43) Pub. Date: Feb. 20, 2003

(54) Wireless local area network using impulse radio technology to improve communications between mobile nodes and access points

(75) Inventors: Thomas M. English, Huntsville, AL (US); S. Scott O'Hanian, Huntsville, AL (US); Matthew S. Nelson, Madison, AL (US); Lee V. Watson, Huntsville, AL (US)

Correspondence Address: WILLIAM J. TUCKER, 8650 SOUTHWESTERN BLVD. #2825, DALLAS, TX, 75206, US

(73) Assignee: Time Domain Corporation

(21) Appl. No.: 09/873,439

(22) Filed: Jun. 4, 2001

(51) Int. Cl. H04M 11/00

(52) U.S. Cl. 455/403; 455/436; 455/456

(57) ABSTRACT

A wireless local area network is provided that uses impulse radio technology to improve communications between a mobile node and access point. In one embodiment of the present invention, a wireless network, a mobile node and a method are provided that use the communication capabilities of impulse radio technology to overcome the problematical “dead zones” and “multipath interference” associated with a traditional wireless LAN. In another embodiment of the present invention, a wireless network, a mobile node and a method are provided that have an improved roaming scheme due to the use of the positioning and tracking capabilities of impulse radio technology. These embodiments and several other embodiments of the present invention are described herein.

### BACKGROUND OF THE INVENTION

1. Field of the Invention

The present invention relates in general to wireless local area networks and, in particular, to a wireless local area network that uses impulse radio technology to improve communications between mobile nodes and access points.

2. Description of Related Art

Traditional local area networks (LANs) use cables to link computers, file servers, printers and other network equipment. These networks enable users to communicate with each other by exchanging electronic mail and accessing multi-user application programs and shared databases. To connect to a LAN, a user device must be physically connected to a fixed outlet or socket, thus creating a network of more or less stationary nodes. Moving from one location to another necessitates disconnecting from the LAN and reconnecting at a new site. Expanding the LAN implies additional cabling, which takes time to deploy, occupies more space and increases overhead costs significantly. These factors make hard-wired LANs expensive and difficult to install, maintain, and especially modify.

The emergence of wireless LANs brings the benefits of user mobility and flexible network deployment into local area computing. With mobility, a network client can migrate between different physical locations within the LAN environment without losing connectivity. Another advantage of wireless LANs is the flexibility one has to reconfigure and expand the network without requiring a lot of planning or paying the cost to rewire the network. Thus, future upgrades to wireless LANs are easy and inexpensive. Moreover, the widespread use of laptop computers and handheld personal digital assistants has led to an increased dependence on wireless LANs.

Unfortunately, traditional wireless LANs are susceptible to problematical “dead zones” within a building that interfere with the wireless link between a mobile node and an access point.

Dead zones are typically caused by the closed structure of a building, which can make it difficult for a mobile node using a standard radio transceiver to maintain contact with a standard radio transceiver attached to the access point. In particular, the standard radio signals sent from the mobile node may not be able to penetrate a certain wall or floor within the building and as such may not reach the access point. This is especially true when the mobile node travels to different locations within the building.

The closed structure of the building may also cause “multipath interference” which can interfere with standard radio transmissions between the mobile node and the access point. Multipath interference is an error caused by the interference of a standard radio signal that has reached a standard radio receiver by two or more paths. Essentially, the standard radio receiver attached to the mobile node or access node may not be able to demodulate the standard radio signal because the transmitted radio signal effectively cancels itself out by bouncing of walls and floors of the building before reaching the mobile node or access node. Accordingly, there has been a need to provide a wireless network, a mobile node and a method that can use the communication capabilities of impulse radio technology to overcome the problematical “dead zones” and “multipath interference” associated with traditional wireless LANs. There has also been a need to provide a wireless network, a mobile node and a method that can use the positioning and tracking capabilities of impulse radio technology to improve the current roaming scheme associated with traditional wireless LANs. These needs and other needs are addressed by the wireless network, the mobile node and the method of the present invention.

### BRIEF DESCRIPTION OF THE INVENTION

The present invention includes a wireless local area network that uses impulse radio technology to improve communications between mobile nodes and access points. In one embodiment of the present invention, a wireless network, a mobile node and a method are provided that use the communication capabilities of impulse radio technology to overcome the problematical “dead zones” and “multipath interference” associated with a traditional wireless LAN. In another embodiment of the present invention, a wireless network, a mobile node and a method are provided that have an improved roaming scheme due to the use of the positioning and tracking capabilities of impulse radio technology. These embodiments and several other embodiments of the present invention are described in greater detail below.

### BRIEF DESCRIPTION OF THE DRAWINGS

A more complete understanding of the present invention may be had by reference to the following detailed description when taken in conjunction with the accompanying drawings wherein:

FIG. 1A illustrates a representative Gaussian Monocycle waveform in the time domain;

FIG. 1B illustrates the frequency domain amplitude of the Gaussian Monocycle of FIG. 1A;

FIG. 1C represents the second derivative of the Gaussian Monocycle of FIG. 1A;

FIG. 1D represents the third derivative of the Gaussian Monocycle of FIG. 1A;

FIG. 1E represents the Correlator Output vs. the Relative Delay in a real data pulse;

FIG. 1F graphically depicts the frequency plot of the Gaussian family of the Gaussian Pulse and the first, second, and third derivative.

FIG. 2A illustrates a pulse train comprising pulses as in FIG. 1A;

FIG. 2B illustrates the frequency domain amplitude of the waveform of FIG. 2A;

FIG. 2C illustrates the pulse train spectrum;

FIG. 2D is a plot of the Frequency vs. Energy Plot and points out the coded signal energy spikes;

FIG. 3 illustrates the cross-correlation of two codes graphically as Coincidences vs. Time Offset;

FIGS. 4A-4E graphically illustrate five modulation techniques to include: Early-Late Modulation; One of Many Modulation; Flip Modulation; Quad Flip Modulation; and Vector Modulation;

FIG. 5A illustrates representative signals of an interfering signal, a coded received pulse train and a coded reference pulse train;

FIG. 5B depicts a typical geometrical configuration giving rise to multipath received signals;

FIG. 5C illustrates exemplary multipath signals in the time domain;

FIGS 5D-5F illustrate a signal plot of various multipath environments.

FIGS. 5G illustrates the Rayleigh fading curve associated with non-impulse radio transmissions in a multipath environment.

FIG. 5H illustrates a plurality of multipaths with a plurality of reflectors from a transmitter to a receiver.

FIG. 5I graphically represents signal strength as volts vs. time in a direct path and multipath environment.

FIG. 6 illustrates a representative impulse radio transmitter functional diagram;

FIG. 7 illustrates a representative impulse radio receiver functional diagram;

FIG. 8A illustrates a representative received pulse signal at the input to the correlator;

FIG. 8B illustrates a sequence of representative impulse signals in the correlation process;

FIG. 8C illustrates the output of the correlator for each of the time offsets of FIG. 8B.

FIG. 9 is a diagram illustrating the basic components of a wireless local area network using the communication capabilities of impulse radio technology to improve communications between mobile nodes and access points in accordance with the present invention.

FIG. 10 is a diagram illustrating the basic components of a wireless local area network using the positioning and tracking capabilities of impulse radio technology to improve a roaming scheme between mobile nodes and access points in accordance with the present invention.

FIG. 11 is a flowchart illustrating the basic steps of a preferred method for using impulse radio technology to improve the communications and/or a roaming scheme between mobile nodes and access points in accordance with the present invention.

FIG. 12 is a block diagram of an impulse radio positioning network utilizing a synchronized transceiver tracking architecture that can be used in the present invention.

FIG. 13 is a block diagram of an impulse radio positioning network utilizing an unsynchronized transceiver tracking architecture that can be used in the present invention.

FIG. 14 is a block diagram of an impulse radio positioning network utilizing a synchronized transmitter tracking architecture that can be used in the present invention.

FIG. 15 is a block diagram of an impulse radio positioning network utilizing an unsynchronized transmitter tracking architecture that can be used in the present invention.

FIG. 16 is a block diagram of an impulse radio positioning network utilizing a synchronized receiver tracking architecture that can be used in the present invention.

FIG. 17 is a block diagram of an impulse radio positioning network utilizing an unsynchronized receiver tracking architecture that can be used in the present invention.

FIG. 18 is a diagram of an impulse radio positioning network utilizing a mixed mode reference radio tracking architecture that can be used in the present invention.

FIG. 19 is a diagram of an impulse radio positioning network utilizing a mixed mode mobile apparatus tracking architecture that can be used in the present invention.

FIG. 20 is a diagram of a steerable null antennae architecture capable of being used in an impulse radio positioning network in accordance the present invention.

FIG. 21 is a diagram of a specialized difference antennae architecture capable of being used in an impulse radio positioning network in accordance the present invention.

FIG. 22 is a diagram of a specialized directional antennae architecture capable of being used in an impulse radio positioning network in accordance with the present invention.

FIG. 23 is a diagram of an amplitude sensing architecture capable of being used in an impulse radio positioning network in accordance with the present invention.

### DETAILED DESCRIPTION OF THE INVENTION

The present invention includes a wireless local area network that uses impulse radio technology to improve communications between mobile nodes and access points. The use of impulse radio technology to help improve communications between mobile nodes and access points is a significant improvement over the state-of-art. This significant improvement over the state-of-art is attributable, in part, to the use of an emerging, revolutionary ultra wideband technology (UWB) called impulse radio communication technology (also known as impulse radio).

Impulse radio has been described in a series of patents, including U.S. Pat. Nos. 4,641,317 (issued Feb. 3, 1987), 4,813,057 (issued Mar. 14, 1989), 4,979,186 (issued Dec. 18, 1990) and 5,363,108 (issued Nov. 8, 1994) to Larry W. Fullerton. A second generation of impulse radio patents includes U.S. Pat. Nos. 5,677,927 (issued Oct. 14, 1997), 5,687,169 (issued Nov. 11, 1997), 5,764,696 (issued Jun. 9, 1998), and 5,832,035 (issued Nov. 3, 1998) to Fullerton et al.

Uses of impulse radio systems are described in U.S. patent application Ser. No. 09/332,502, titled, “System and Method for Intrusion Detection using a Time Domain Radar Array” and U.S. patent application Ser. No. 09/332,503, titled, “Wide Area Time Domain Radar Array” both filed on Jun. 14, 1999 both of which are assigned to the assignee of the present invention. The above patent documents are incorporated herein by reference.

This section provides an overview of impulse radio technology and relevant aspects of communications theory. It is provided to assist the reader with understanding the present invention and should not be used to limit the scope of the present invention. It should be understood that the terminology ‘impulse radio’ is used primarily for historical convenience and that the terminology can be generally interchanged with the terminology ‘impulse communications system, ultra-wideband system, or ultra-wideband communication systems’. Furthermore, it should be understood that the described impulse radio technology is generally applicable to various other impulse system applications including but not limited to impulse radar systems and impulse positioning systems. Accordingly, the terminology ‘impulse radio’ can be generally interchanged with the terminology ‘impulse transmission system and impulse reception system.’

Impulse radio refers to a radio system based on short, low duty-cycle pulses. An ideal impulse radio waveform is a short Gaussian monocycle. As the name suggests, this waveform attempts to approach one cycle of radio frequency (RF) energy at a desired center frequency. Due to implementation and other spectral limitations, this waveform may be altered significantly in practice for a given application. Many waveforms having very broad, or wide, spectral bandwidth approximate a Gaussian shape to a useful degree.

Impulse radio can use many types of modulation, including amplitude modulation, phase modulation, frequency modulation, time-shift modulation (also referred to as pulse-position modulation or pulse-interval modulation) and M-ary versions of these. In this document, the time-shift modulation method is often used as an illustrative example. However, someone skilled in the art will recognize that alternative modulation approaches may, in some instances, be used instead of or in combination with the time-shift modulation approach.

In impulse radio communications, inter-pulse spacing may be held constant or may be varied on a pulse-by-pulse basis by information, a code, or both. Generally, conventional spread spectrum systems employ codes to spread the normally narrow band information signal over a relatively wide band of frequencies. A conventional spread spectrum receiver correlates these signals to retrieve the original information signal. In impulse radio communications, codes are not typically used for energy spreading because the monocycle pulses themselves have an inherently wide bandwidth. Codes are more commonly used for channelization, energy smoothing in the frequency domain, resistance to interference, and reducing the interference potential to nearby receivers. Such codes are commonly referred to as time-hopping codes or pseudo-noise (PN) codes since their use typically causes inter-pulse spacing to have a seemingly random nature. PN codes may be generated by techniques other than pseudorandom code generation. Additionally, pulse trains having constant, or uniform, pulse spacing are commonly referred to as uncoded pulse trains. A pulse train with uniform pulse spacing, however, may be described by a code that specifies non-temporal, i.e., non-time related, pulse characteristics.

In impulse radio communications utilizing time-shift modulation, information comprising one or more bits of data typically time-position modulates a sequence of pulses. This yields a modulated, coded timing signal that comprises a train of pulses from which a typical impulse radio receiver employing the same code may demodulate and, if necessary, coherently integrate pulses to recover the transmitted information.

The impulse radio receiver is typically a direct conversion receiver with a cross correlator front-end that coherently converts an electromagnetic pulse train of monocycle pulses to a baseband signal in a single stage. The baseband signal is the basic information signal for the impulse radio communications system. A subcarrier may also be included with the baseband signal to reduce the effects of amplifier drift and low frequency noise. Typically, the subcarrier alternately reverses modulation according to a known pattern at a rate faster than the data rate. This same pattern is used to reverse the process and restore the original data pattern just before detection. This method permits alternating current (AC) coupling of stages, or equivalent signal processing, to eliminate direct current (DC) drift and errors from the detection process. This method is described in more detail in U.S. Pat. No. 5,677,927 to Fullerton et al.

Waveforms

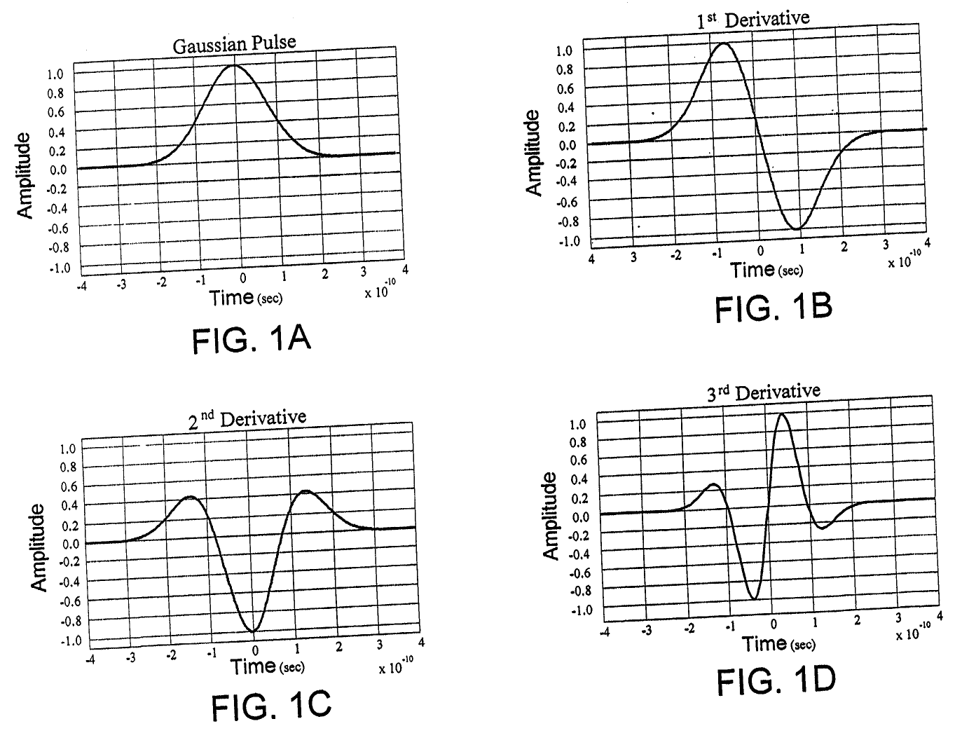

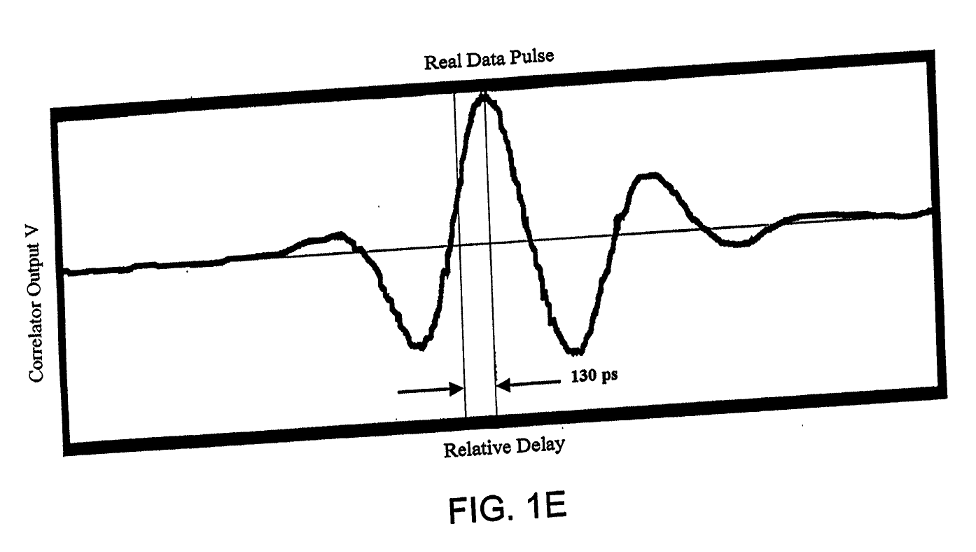

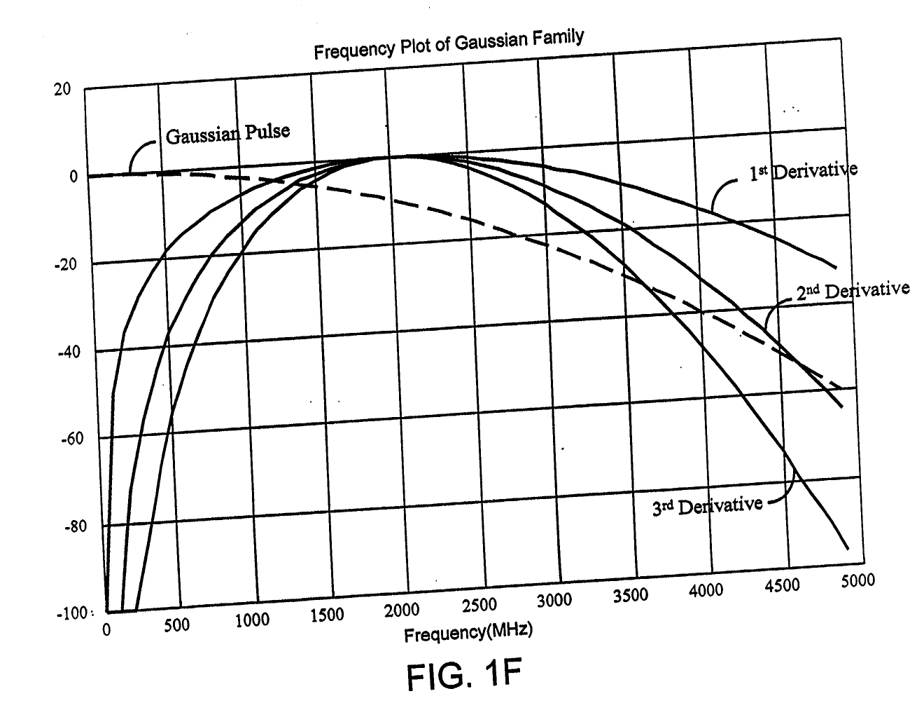

Impulse transmission systems are based on short, low duty-cycle pulses. Different pulse waveforms, or pulse types, may be employed to accommodate requirements of various applications. Typical pulse types include a Gaussian pulse, pulse doublet (also referred to as a Gaussian monocycle), pulse triplet, and pulse quadlet as depicted in FIGS. 1A through 1D, respectively. An actual received waveform that closely resembles the theoretical pulse quadlet is shown in FIG. 1E. A pulse type may also be a wavelet set produced by combining two or more pulse waveforms (e.g., a doublet/triplet wavelet set). These different pulse types may be produced by methods described in the patent documents referenced above or by other methods, as persons skilled in the art would understand.

For analysis purposes, it is convenient to model pulse waveforms in an ideal manner. For example, the transmitted waveform produced by supplying a step function into an ultra-wideband antenna may be modeled as a Gaussian monocycle. A Gaussian monocycle (normalized to a peak value of 1) may be described by:

$${f}_{mono} ( t ) = \sqrt{e} ( \frac{t}{σ} ) {ⅇ}^{\frac{- {t}^{2}}{2 {σ}^{2}}}$$

where σ is a time scaling parameter, t is time, and e is the natural logarithm base.

The power special density of the Gaussian monocycle is shown in FIG. 1F, along with spectrums for the Gaussian pulse, triplet, and quadlet. The corresponding equation for the Gaussian monocycle is:

F_{mono(f)=((}2π) 3/2σfe^{-2(πσf)}^{²}

The center frequency (f_{c}), or frequency of peak spectral density, of the Gaussian monocycle is:

$${f}_{c} = \frac{1}{2 π σ}$$

It should be noted that the output of an ultra-wideband antenna is essentially equal to the derivative of its input. Accordingly, since the pulse doublet, pulse triplet, and pulse quadlet are the first, second, and third derivatives of the Gaussian pulse, in an ideal model, an antenna receiving a Gaussian pulse will transmit a Gaussian monocycle and an antenna receiving a Gaussian monocycle will provide a pulse triplet.

Pulse Trains

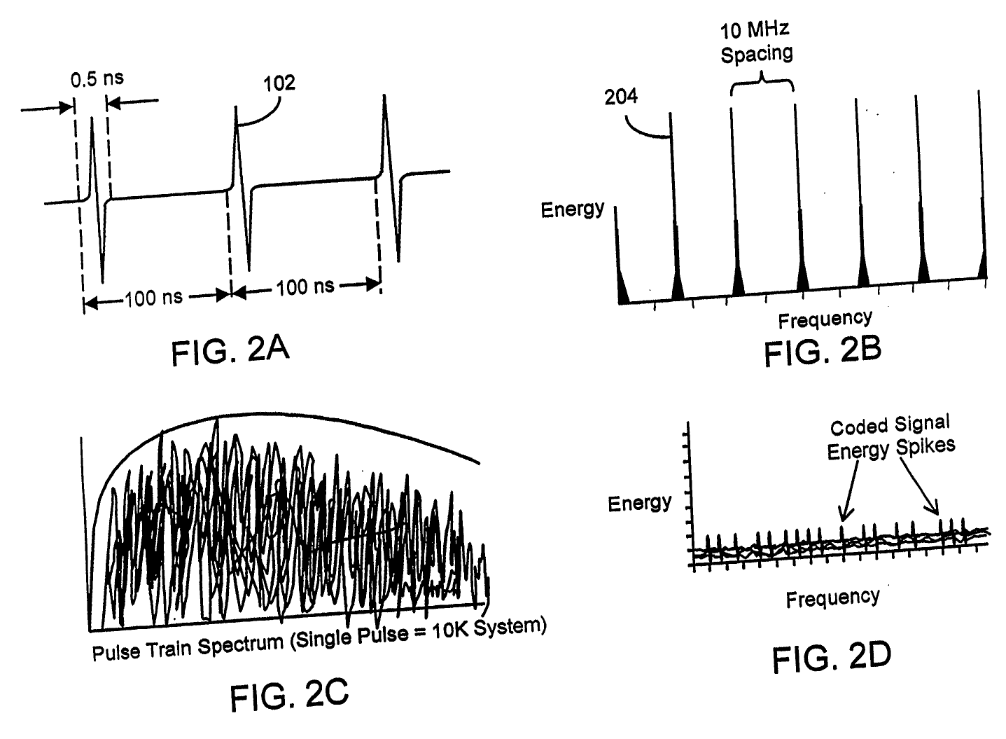

Impulse transmission systems may communicate one or more data bits with a single pulse; however, typically each data bit is communicated using a sequence of pulses, known as a pulse train. As described in detail in the following example system, the impulse radio transmitter produces and outputs a train of pulses for each bit of information. FIGS. 2A and 2B are illustrations of the output of a typical 10 megapulses per second (Mpps) system with uncoded, unmodulated pulses, each having a width of 0.5 nanoseconds (ns). FIG. 2A shows a time domain representation of the pulse train output. FIG. 2B illustrates that the result of the pulse train in the frequency domain is to produce a spectrum comprising a set of comb lines spaced at the frequency of the 10 Mpps pulse repetition rate. When the full spectrum is shown, as in FIG. 2C, the envelope of the comb line spectrum corresponds to the curve of the single Gaussian monocycle spectrum in FIG. 1F. For this simple uncoded case, the power of the pulse train is spread among roughly two hundred comb lines. Each comb line thus has a small fraction of the total power and presents much less of an interference problem to a receiver sharing the band. It can also be observed from FIG. 2A that impulse transmission systems typically have very low average duty cycles, resulting in average power lower than peak power. The duty cycle of the signal in FIG. 2A is 0.5%, based on a 0.5 ns pulse duration in a 100 ns interval.

The signal of an uncoded, unmodulated pulse train may be expressed:

$$s ( t ) = {( - 1 )}^{f} a {\sum }_{j} ω ( ct - {jT}_{f} , b )$$

where j is the index of a pulse within a pulse train, (−1)^{f} is polarity (+/−), a is pulse amplitude, b is pulse type, c is pulse width, ω(t,b) is the normalized pulse waveform, and T_{f} is pulse repetition time.

The energy spectrum of a pulse train signal over a frequency bandwidth of interest may be determined by summing the phasors of the pulses at each frequency, using the following equation:

$$A ( ω ) = \vert {\sum }_{i = 1}^{n} \frac{{ⅇ}^{j Δ t}}{n} \vert$$

where A(ω) is the amplitude of the spectral response at a given frequency□□ω□ is the frequency being analyzed (2πf), Δt is the relative time delay of each pulse from the start of time period, and n is the total number of pulses in the pulse train.

A pulse train can also be characterized by its autocorrelation and cross-correlation properties. Autocorrelation properties pertain to the number of pulse coincidences (i.e., simultaneous arrival of pulses) that occur when a pulse train is correlated against an instance of itself that is offset in time. Of primary importance is the ratio of the number of pulses in the pulse train to the maximum number of coincidences that occur for any time offset across the period of the pulse train. This ratio is commonly referred to as the main-lobe-to-side-lobe ratio, where the greater the ratio, the easier it is to acquire and track a signal.

Cross-correlation properties involve the potential for pulses from two different signals simultaneously arriving, or coinciding, at a receiver. Of primary importance are the maximum and average numbers of pulse coincidences that may occur ? between two pulse trains. As the number of coincidences increases, the propensity for data errors increases. Accordingly, pulse train cross-correlation properties are used in determining channelization capabilities of impulse transmission systems (i.e., the ability to simultaneously operate within close proximity).

Coding

Specialized coding techniques can be employed to specify temporal and/or non-temporal pulse characteristics to produce a pulse train having certain spectral and/or correlation properties. For example, by employing a PN code to vary inter-pulse spacing, the energy in the comb lines presented in FIG. 2B can be distributed to other frequencies as depicted in FIG. 2D, thereby decreasing the peak spectral density within a bandwidth of interest. Note that the spectrum retains certain properties that depend on the specific (temporal) PN code used. Spectral properties can be similarly affected by using non-temporal coding (e.g., inverting certain pulses).

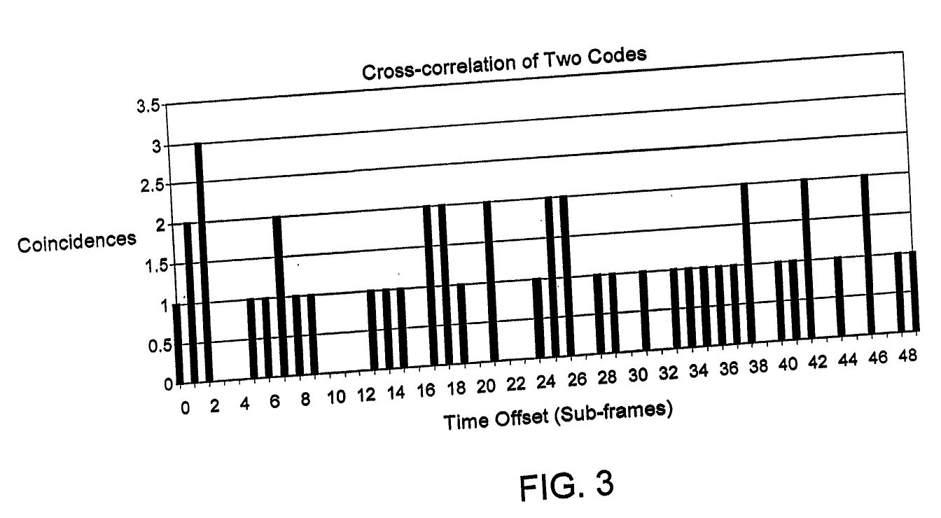

Coding provides a method of establishing independent communication channels. Specifically, families of codes can be designed such that the number of pulse coincidences between pulse trains produced by any two codes will be minimal. For example, FIG. 3 depicts cross-correlation properties of two codes that have no more than four coincidences for any time offset. Generally, keeping the number of pulse collisions minimal represents a substantial attenuation of the unwanted signal.

Coding can also be used to facilitate signal acquisition. For example, coding techniques can be used to produce pulse trains with a desirable main-lobe-to-side-lobe ratio. In addition, coding can be used to reduce acquisition algorithm search space.

Coding methods for specifying temporal and non-temporal pulse characteristics are described in commonly owned, co-pending applications titled “A Method and Apparatus for Positioning Pulses in Time,” application Ser. No. 09/592,249, and “A Method for Specifying Non-Temporal Pulse Characteristics,” application Ser. No. 09/592,250, both filed Jun. 12, 2000, and both of which are incorporated herein by reference.

Typically, a code consists of a number of code elements having integer or floating-point values. A code element value may specify a single pulse characteristic or may be subdivided into multiple components, each specifying a different pulse characteristic. Code element or code component values typically map to a pulse characteristic value layout that may be fixed or non-fixed and may involve value ranges, discrete values, or a combination of value ranges and discrete values. A value range layout specifies a range of values that is divided into components that are each subdivided into subcomponents, which can be further subdivided, as desired. In contrast, a discrete value layout involves uniformly or non-uniformly distributed discrete values. A non-fixed layout (also referred to as a delta layout) involves delta values relative to some reference value. Fixed and non-fixed layouts, and approaches for mapping code element/component values, are described in co-owned, co-pending applications, titled “Method for Specifying Pulse Characteristics using Codes,” application Ser. No. 09/592,290 and “A Method and Apparatus for Mapping Pulses to a Non-Fixed Layout,” application Ser. No. 09/591,691, both filed on Jun. 12, 2000, both of which are incorporated herein by reference.

A fixed or non-fixed characteristic value layout may include a non-allowable region within which a pulse characteristic value is disallowed. A method for specifying non-allowable regions is described in co-owned, co-pending application titled “A Method for Specifying Non-Allowable Pulse Characteristics,” application Ser. No. 09/592,289, filed Jun. 12, 2000, and incorporated herein by reference. A related method that conditionally positions pulses depending on whether code elements map to non-allowable regions is described in co-owned, co-pending application, titled “A Method and Apparatus for Positioning Pulses Using a Layout having Non-Allowable Regions,” application Ser. No. 09/592,248 filed Jun. 12, 2000, and incorporated herein by reference.

The signal of a coded pulse train can be generally expressed by:

$${s}_{tr}^{( k )} ( t ) = {\sum }_{j} {( - 1 )}^{{f}_{j}^{( k )}} {a}_{j}^{( k )} ω ( {c}_{j}^{( k )} t - {T}_{j}^{( k )} , {b}_{j}^{( k )} )$$

where k is the index of a transmitter, j is the index of a pulse within its pulse train, (−1)fⱼ^{(k)}, aⱼ^{(k)}, bⱼ^{(k)}, cⱼ^{(k)}, and ω(t,bⱼ^{(k)}) are the coded polarity, pulse amplitude, pulse type, pulse width, and normalized pulse waveform of the jth pulse of the kth transmitter, and Tⱼ^{(k)} is the coded time shift of the jth pulse of the kth transmitter. Note: When a given non-temporal characteristic does not vary (i.e., remains constant for all pulses), it becomes a constant in front of the summation sign.

Various numerical code generation methods can be employed to produce codes having certain correlation and spectral properties. Such codes typically fall into one of two categories: designed codes and pseudorandom codes. A designed code may be generated using a quadratic congruential, hyperbolic congruential, linear congruential, Costas array, or other such numerical code generation technique designed to generate codes having certain correlation properties. A pseudorandom code may be generated using a computer's random number generator, binary shift-register(s) mapped to binary words, a chaotic code generation scheme, or the like. Such ‘random-like’ codes are attractive for certain applications since they tend to spread spectral energy over multiple frequencies while having ‘good enough’ correlation properties, whereas designed codes may have superior correlation properties but possess less suitable spectral properties. Detailed descriptions of numerical code generation techniques are included in a co-owned, co-pending patent application titled “A Method and Apparatus for Positioning Pulses in Time,” application Ser. No. 09/592,248, filed Jun. 12, 2000, and incorporated herein by reference.

It may be necessary to apply predefined criteria to determine whether a generated code, code family, or a subset of a code is acceptable for use with a given UWB application. Criteria may include correlation properties, spectral properties, code length, non-allowable regions, number of code family members, or other pulse characteristics. A method for applying predefined criteria to codes is described in co-owned, co-pending application, titled “A Method and Apparatus for Specifying Pulse Characteristics using a Code that Satisfies Predefined Criteria,” application Ser. No. 09/592,288, filed Jun. 12, 2000, and incorporated herein by reference.

In some applications, it may be desirable to employ a combination of codes. Codes may be combined sequentially, nested, or sequentially nested, and code combinations may be repeated. Sequential code combinations typically involve switching from one code to the next after the occurrence of some event and may also be used to support multicast communications. Nested code combinations may be employed to produce pulse trains having desirable correlation and spectral properties. For example, a designed code may be used to specify value range components within a layout and a nested pseudorandom code may be used to randomly position pulses within the value range components. With this approach, correlation properties of the designed code are maintained since the pulse positions specified by the nested code reside within the value range components specified by the designed code, while the random positioning of the pulses within the components results in particular spectral properties. A method for applying code combinations is described in co-owned, co-pending application, titled “A Method and Apparatus for Applying Codes Having Pre-Defined Properties,” application Ser. No. 09/591,690, filed Jun. 12, 2000, and incorporated herein by reference.

Modulation

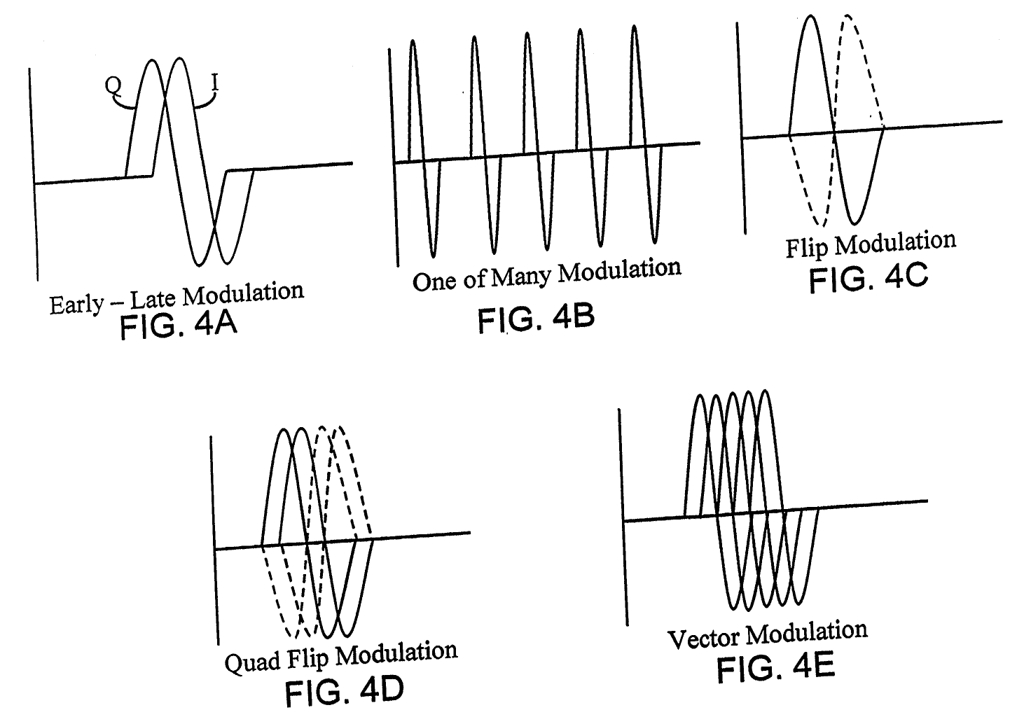

Various aspects of a pulse waveform may be modulated to convey information and to further minimize structure in the resulting spectrum. Amplitude modulation, phase modulation, frequency modulation, time-shift modulation and M-ary versions of these were proposed in U.S. Pat. No. 5,677,927 to Fullerton et al., previously incorporated by reference. Time-shift modulation can be described as shifting the position of a pulse either forward or backward in time relative to a nominal coded (or uncoded) time position in response to an information signal. Thus, each pulse in a train of pulses is typically delayed a different amount from its respective time base clock position by an individual code delay amount plus a modulation time shift. This modulation time shift is normally very small relative to the code shift. In a 10 Mpps system with a center frequency of 2 GHz, for example, the code may command pulse position variations over a range of 100 ns, whereas, the information modulation may shift the pulse position by 150 ps. This two-state ‘early-late’ form of time shift modulation is depicted in FIG. 4A.

A pulse train with conventional ‘early-late’ time-shift modulation can be expressed:

$${s}_{tr}^{( k )} ( t ) = {\sum }_{j} {( - 1 )}^{{f}_{j}^{( k )}} {a}_{j}^{( k )} ω ( {c}_{j}^{( k )} t - {T}_{j}^{( k )} - δ {d}_{[ j / {N}_{s} ]}^{( k )} , {b}_{j}^{( k )} )$$

where k is the index of a transmitter, j is the index of a pulse within its pulse train, (−1)fⱼ^{(k)}, aⱼ^{(k)}, bⱼ^{(k)}, cⱼ^{(k)}, and ω(t,bⱼ^{(k)}) are the coded polarity, pulse amplitude, pulse type, pulse width, and normalized pulse waveform of the jth pulse of the kth transmitter, Tⱼ^{(k)} is the coded time shift of the jth pulse of the kth transmitter, d is the time shift added when the transmitted symbol is 1 (instead of 0), d^{(k)} is the data (i.e., 0 or 1) transmitted by the kth transmitter, and Nₛ is the number of pulses per symbol (e.g., bit). Similar expressions can be derived to accommodate other proposed forms of modulation.

An alternative form of time-shift modulation can be described as One-of-Many Position Modulation (OMPM). The OMPM approach, shown in FIG. 4B, involves shifting a pulse to one of N possible modulation positions about a nominal coded (or uncoded) time position in response to an information signal, where N represents the number of possible states. For example, if N were four (4), two data bits of information could be conveyed. For further details regarding OMPM, see “Apparatus, System and Method for One-of-Many Position Modulation in an Impulse Radio Communication System,” Attorney Docket No. 1659.0860000, filed Jun. 7, 2000, assigned to the assignee of the present invention, and incorporated herein by reference.

An impulse radio communications system can employ flip modulation techniques to convey information. The simplest flip modulation technique involves transmission of a pulse or an inverted (or flipped) pulse to represent a data bit of information, as depicted in FIG. 4C. Flip modulation techniques may also be combined with time-shift modulation techniques to create two, four, or more different data states. One such flip with shift modulation technique is referred to as Quadrature Flip Time Modulation (QFTM). The QFTM approach is illustrated in FIG. 4D. Flip modulation techniques are further described in patent application titled “Apparatus, System and Method for Flip Modulation in an Impulse Radio Communication System,” application Ser. No. 09/537,692, filed Mar. 29, 2000, assigned to the assignee of the present invention, and incorporated herein by reference.

Vector modulation techniques may also be used to convey information. Vector modulation includes the steps of generating and transmitting a series of time-modulated pulses, each pulse delayed by one of at least four pre-determined time delay periods and representative of at least two data bits of information, and receiving and demodulating the series of time-modulated pulses to estimate the data bits associated with each pulse. Vector modulation is shown in FIG. 4E. Vector modulation techniques are further described in patent application titled “Vector Modulation System and Method for Wideband Impulse Radio Communications,” application Ser. No. 09/169,765, filed Dec. 9, 1999, assigned to the assignee of the present invention, and incorporated herein by reference.

Reception and Demodulation

Impulse radio systems operating within close proximity to each other may cause mutual interference. While coding minimizes mutual interference, the probability of pulse collisions increases as the number of coexisting impulse radio systems rises. Additionally, various other signals may be present that cause interference. Impulse radios can operate in the presence of mutual interference and other interfering signals, in part because they do not depend on receiving every transmitted pulse. Impulse radio receivers perform a correlating, synchronous receiving function (at the RF level) that uses statistical sampling and combining, or integration, of many pulses to recover transmitted information. Typically, 1 to 1000 or more pulses are integrated to yield a single data bit thus diminishing the impact of individual pulse collisions, where the number of pulses that must be integrated to successfully recover transmitted information depends on a number of variables including pulse rate, bit rate, range and interference levels.

Interference Resistance

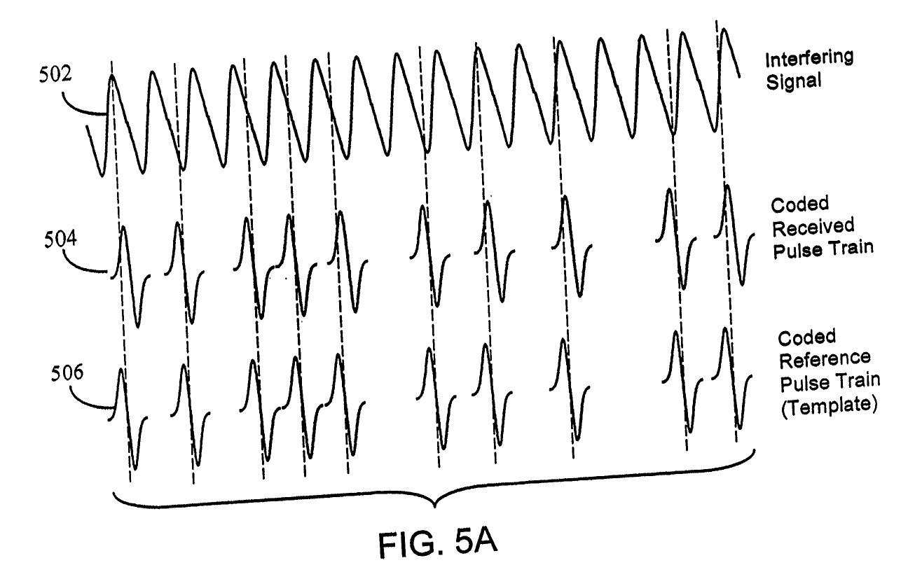

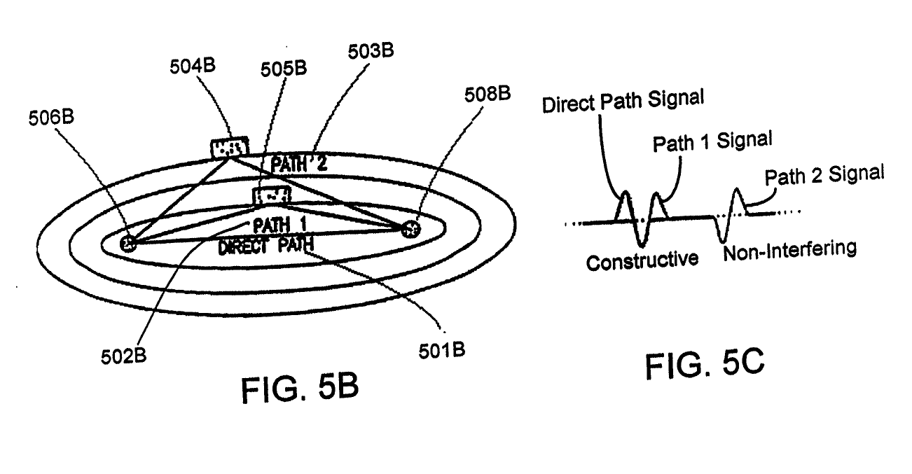

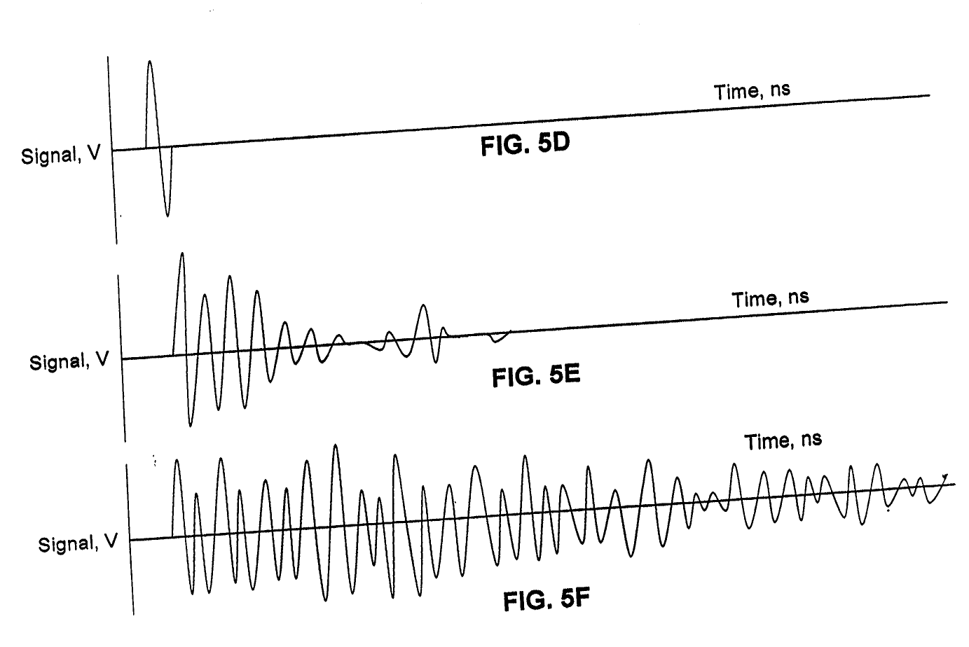

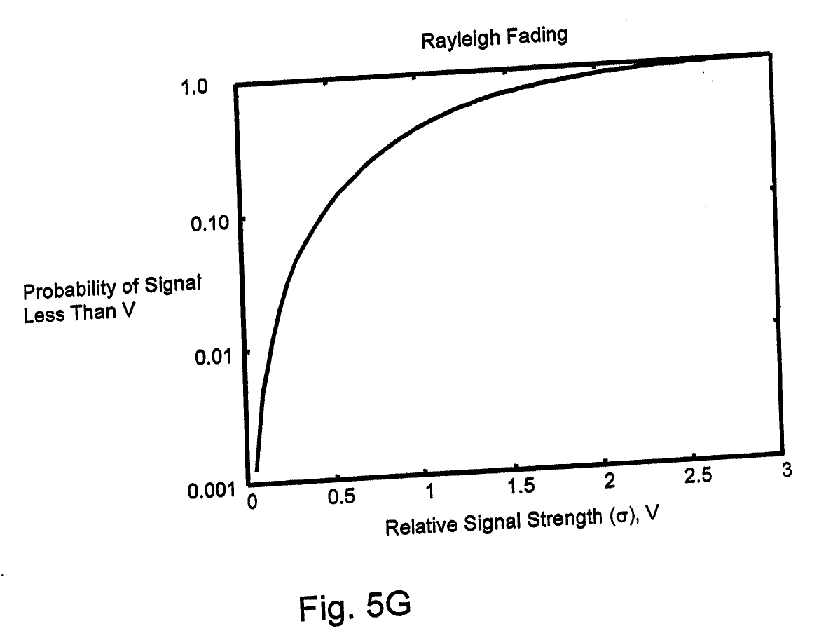

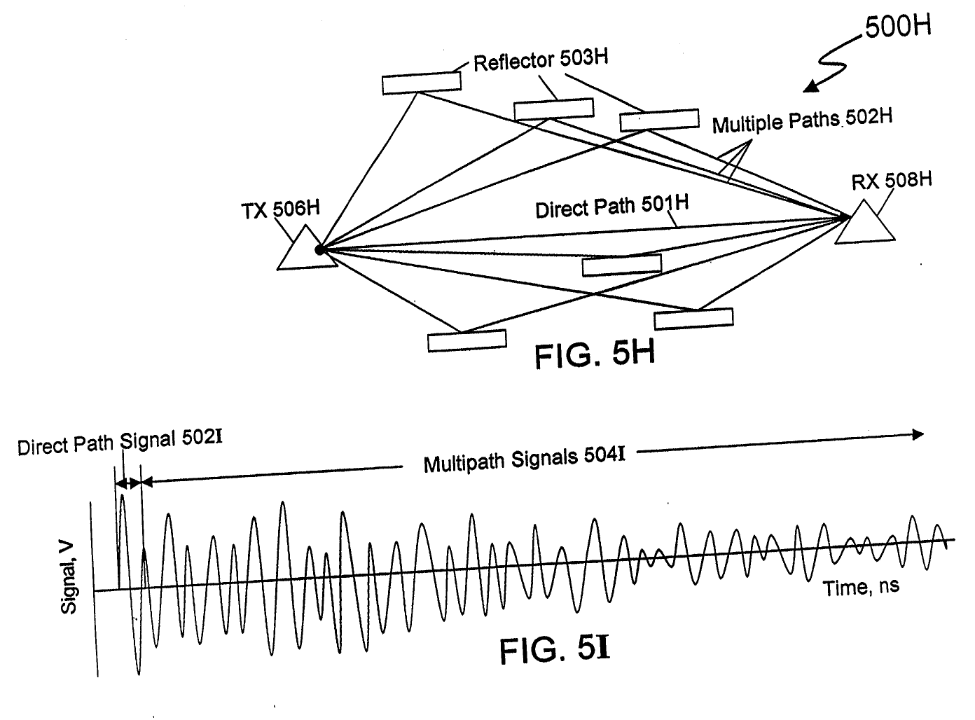

Besides providing channelization and energy smoothing, coding makes impulse radios highly resistant to interference by enabling discrimination between intended impulse transmissions and interfering transmissions. This property is desirable since impulse radio systems must share the energy spectrum with conventional radio systems and with other impulse radio systems. FIG. 5A illustrates the result of a narrow band sinusoidal interference signal 502 overlaying an impulse radio signal 504. At the impulse radio receiver, the input to the cross correlation would include the narrow band signal 502 and the received ultrawide-band impulse radio signal 504. The input is sampled by the cross correlator using a template signal 506 positioned in accordance with a code. Without coding, the cross correlation would sample the interfering signal 502 with such regularity that the interfering signals could cause interference to the impulse radio receiver. However, when the transmitted impulse signal is coded and the impulse radio receiver template signal 506 is synchronized using the identical code, the receiver samples the interfering signals non-uniformly. The samples from the interfering signal add incoherently, increasing roughly according to the square root of the number of samples integrated. The impulse radio signal samples, however, add coherently, increasing directly according to the number of samples integrated. Thus, integrating over many pulses overcomes the impact of interference.

Processing Gain

Impulse radio systems have exceptional processing gain due to their wide spreading bandwidth. For typical spread spectrum systems, the definition of processing gain, which quantifies the decrease in channel interference when wide-band communications are used, is the ratio of the bandwidth of the channel to the bit rate of the information signal. For example, a direct sequence spread spectrum system with a 10 KHz information bandwidth and a 10 MHz channel bandwidth yields a processing gain of 1000, or 30 dB. However, far greater processing gains are achieved by impulse radio systems, where the same 10 KHz information bandwidth is spread across a much greater 2 GHz channel bandwidth, resulting in a theoretical processing gain of 200,000, or 53 dB.

Capacity

It can be shown theoretically, using signal-to-noise arguments, that thousands of simultaneous channels are available to an impulse radio system as a result of its exceptional processing gain.

The average output signal-to-noise ratio of the impulse radio may be calculated for randomly selected time-hopping codes as a function of the number of active users, Nᵤ, as:

$${SNR}_{out} ( {N}_{u} ) = \frac{{( {N}_{s} {A}_{1} {m}_{p} )}^{2}}{{σ}_{rec}^{2} + {N}_{s} {σ}_{a}^{2} {\sum }_{k = 2}^{{N}_{u}} {A}_{k}^{2}}$$

where Nₛ is the number of pulses integrated per bit of information, Aₖ models the attenuation of transmitter k's signal over the propagation path to the receiver, and σ_{rec}² is the variance of the receiver noise component at the pulse train integrator output. The monocycle waveform-dependent parameters mₚ and σₐ² are given by

$${m}_{p} = {\int }_{- ∞}^{∞} ω ( t ) [ ω ( t ) - ω ( t - δ ) ] ⅆ t$$

$$\text{and}$$

$${σ}_{a}^{2} = {T}_{f}^{- 1} {\int }_{- ∞}^{∞} {[ {\int }_{- ∞}^{∞} ω ( t - s ) υ ( t ) ⅆ t ]}^{2} ⅆ s ,$$

where ?(t) is the monocycle waveform, ?(t)=?(t)=?(t−d) is the template signal waveform, d is the time shift between the monocycle waveform and the template signal waveform, T_{f} is the pulse repetition time, and s is signal.

Multipath and Propagation

One of the advantages of impulse radio is its resistance to multipath fading effects. Conventional narrow band systems are subject to multipath through the Rayleigh fading process, where the signals from many delayed reflections combine at the receiver antenna according to their seemingly random relative phases resulting in possible summation or possible cancellation, depending on the specific propagation to a given location. Multipath fading effects are most adverse where a direct path signal is weak relative to multipath signals, which represents the majority of the potential coverage area of a radio system. In a mobile system, received signal strength fluctuates due to the changing mix of multipath signals that vary as its position varies relative to fixed transmitters, mobile transmitters and signal-reflecting surfaces in the environment.

Impulse radios, however, can be substantially resistant to multipath effects. Impulses arriving from delayed multipath reflections typically arrive outside of the correlation time and, thus, may be ignored. This process is described in detail with reference to FIGS. 5B and 5C. FIG. 5B illustrates a typical multipath situation, such as in a building, where there are many reflectors 504B, 505B. In this figure, a transmitter 506B transmits a signal that propagates along three paths, the direct path 501B, path 1 502B, and path 2 503B, to a receiver 508B, where the multiple reflected signals are combined at the antenna. The direct path 501B, representing the straight-line distance between the transmitter and receiver, is the shortest. Path 1 502B represents a multipath reflection with a distance very close to that of the direct path. Path 2 503B represents a multipath reflection with a much longer distance. Also shown are elliptical (or, in space, ellipsoidal) traces that represent other possible locations for reflectors that would produce paths having the same distance and thus the same time delay.

FIG. 5C illustrates the received composite pulse waveform resulting from the three propagation paths 501B, 502B, and 503B shown in FIG. 5B. In this figure, the direct path signal 501B is shown as the first pulse signal received. The path 1 and path 2 signals 502B, 503B comprise the remaining multipath signals, or multipath response, as illustrated. The direct path signal is the reference signal and represents the shortest propagation time. The path 1 signal is delayed slightly and overlaps and enhances the signal strength at this delay value. The path 2 signal is delayed sufficiently that the waveform is completely separated from the direct path signal. Note that the reflected waves are reversed in polarity. If the correlator template signal is positioned such that it will sample the direct path signal, the path 2 signal will not be sampled and thus will produce no response. However, it can be seen that the path 1 signal has an effect on the reception of the direct path signal since a portion of it would also be sampled by the template signal. Generally, multipath signals delayed less than one quarter wave (one quarter wave is about 1.5 inches, or 3.5 cm at 2 GHz center frequency) may attenuate the direct path signal. This region is equivalent to the first Fresnel zone in narrow band systems. Impulse radio, however, has no further nulls in the higher Fresnel zones. This ability to avoid the highly variable attenuation from multipath gives impulse radio significant performance advantages.

FIGS. 5D, 5E, and 5F represent the received signal from a TM-UWB transmitter in three different multipath environments. These figures are approximations of typical signal plots. FIG. 5D illustrates the received signal in a very low multipath environment. This may occur in a building where the receiver antenna is in the middle of a room and is a relatively short, distance, for example, one meter, from the transmitter. This may also represent signals received from a larger distance, such as 100 meters, in an open field where there are no objects to produce reflections. In this situation, the predominant pulse is the first received pulse and the multipath reflections are too weak to be significant. FIG. 5E illustrates an intermediate multipath environment. This approximates the response from one room to the next in a building. The amplitude of the direct path signal is less than in FIG. 5D and several reflected signals are of significant amplitude. FIG. 5F approximates the response in a severe multipath environment such as propagation through many rooms, from corner to corner in a building, within a metal cargo hold of a ship, within a metal truck trailer, or within an intermodal shipping container. In this scenario, the main path signal is weaker than in FIG. 5E. In this situation, the direct path signal power is small relative to the total signal power from the reflections.

An impulse radio receiver can receive the signal and demodulate the information using either the direct path signal or any multipath signal peak having sufficient signal-to-noise ratio. Thus, the impulse radio receiver can select the strongest response from among the many arriving signals. In order for the multipath signals to cancel and produce a null at a given location, dozens of reflections would have to be cancelled simultaneously and precisely while blocking the direct path, which is a highly unlikely scenario. This time separation of mulitipath signals together with time resolution and selection by the receiver permit a type of time diversity that virtually eliminates cancellation of the signal. In a multiple correlator rake receiver, performance is further improved by collecting the signal power from multiple signal peaks for additional signal-to-noise performance.

Where the system of FIG. 5B is a narrow band system and the delays are small relative to the data bit time, the received signal is a sum of a large number of sine waves of random amplitude and phase. In the idealized limit, the resulting envelope amplitude has been shown to follow a Rayleigh probability distribution as follows:

$$p ( r ) = \frac{r}{{σ}^{2}} exp ( \frac{- {r}^{2}}{2 {σ}^{2}} )$$

where r is the envelope amplitude of the combined multipath signals, and s(2)^{1/2} is the RMS power of the combined multipath signals. The Rayleigh distribution curve in FIG. 5G shows that 10% of the time, the signal is more than 10 dB attenuated. This suggests that 10 dB fade margin is needed to provide 90% link availability. Values of fade margin from 10 to 40 dB have been suggested for various narrow band systems, depending on the required reliability. This characteristic has been the subject of much research and can be partially improved by such techniques as antenna and frequency diversity, but these techniques result in additional complexity and cost.

In a high multipath environment such as inside homes, offices, warehouses, automobiles, trailers, shipping containers, or outside in an urban canyon or other situations where the propagation is such that the received signal is primarily scattered energy, impulse radio systems can avoid the Rayleigh fading mechanism that limits performance of narrow band systems, as illustrated in FIGS. 5H and 5I. FIG. 5H depicts an impulse radio system in a high multipath environment 500H consisting of a transmitter 506H and a receiver 508H. A transmitted signal follows a direct path 501H and reflects off reflectors 503H via multiple paths 502H. FIG. 5I illustrates the combined signal received by the receiver 508H over time with the vertical axis being signal strength in volts and the horizontal axis representing time in nanoseconds. The direct path 501H results in the direct path signal 502I while the multiple paths 502H result in multipath signals 504I. In the same manner described earlier for FIGS. 5B and 5C, the direct path signal 502I is sampled, while the multipath signals 504I are not, resulting in Rayleigh fading avoidance.

Distance Measurement and Positioning

Impulse systems can measure distances to relatively fine resolution because of the absence of ambiguous cycles in the received waveform. Narrow band systems, on the other hand, are limited to the modulation envelope and cannot easily distinguish precisely which RF cycle is associated with each data bit because the cycle-to-cycle amplitude differences are so small they are masked by link or system noise. Since an impulse radio waveform has no multi-cycle ambiguity, it is possible to determine waveform position to less than a wavelength, potentially down to the noise floor of the system. This time position measurement can be used to measure propagation delay to determine link distance to a high degree of precision. For example, 30 ps of time transfer resolution corresponds to approximately centimeter distance resolution. See, for example, U.S. Pat. No. 6,133,876, issued Oct. 17, 2000, titled “System and Method for Position Determination by Impulse Radio,” and U.S. Pat. No. 6,111,536, issued Aug. 29, 2000, titled “System and Method for Distance Measurement by Inphase and Quadrature Signals in a Radio System,” both of which are incorporated herein by reference.

In addition to the methods articulated above, impulse radio technology along with Time Division Multiple Access algorithms and Time Domain packet radios can achieve geo-positioning capabilities in a radio network. This geo-positioning method is described in co-owned, co-pending application titled “System and Method for Person or Object Position Location Utilizing Impulse Radio,” application Ser. No. 09/456,409, filed Dec. 8, 1999, and incorporated herein by reference.

Power Control

Power control systems comprise a first transceiver that transmits an impulse radio signal to a second transceiver. A power control update is calculated according to a performance measurement of the signal received at the second transceiver. The transmitter power of either transceiver, depending on the particular setup, is adjusted according to the power control update. Various performance measurements are employed to calculate a power control update, including bit error rate, signal-to-noise ratio, and received signal strength, used alone or in combination. Interference is thereby reduced, which may improve performance where multiple impulse radios are operating in close proximity and their transmissions interfere with one another. Reducing the transmitter power of each radio to a level that produces satisfactory reception increases the total number of radios that can operate in an area without saturation. Reducing transmitter power also increases transceiver efficiency.

For greater elaboration of impulse radio power control, see patent application titled “System and Method for Impulse Radio Power Control,” application Ser. No. 09/332,501, filed Jun. 14, 1999, assigned to the assignee of the present invention, and incorporated herein by reference.

Mitigating Effects of Interference

A method for mitigating interference in impulse radio systems comprises the steps of conveying the message in packets, repeating conveyance of selected packets to make up a repeat package, and conveying the repeat package a plurality of times at a repeat period greater than twice the period of occurrence of the interference. The communication may convey a message from a proximate transmitter to a distal receiver, and receive a message by a proximate receiver from a distal transmitter. In such a system, the method comprises the steps of providing interference indications by the distal receiver to the proximate transmitter, using the interference indications to determine predicted noise periods, and operating the proximate transmitter to convey the message according to at least one of the following: (1) avoiding conveying the message during noise periods, (2) conveying the message at a higher power during noise periods, (3) increasing error detection coding in the message during noise periods, (4) re-transmitting the message following noise periods, (5) avoiding conveying the message when interference is greater than a first strength, (6) conveying the message at a higher power when the interference is greater than a second strength, (7) increasing error detection coding in the message when the interference is greater than a third strength, and (8) re-transmitting a portion of the message after interference has subsided to less than a predetermined strength.

For greater elaboration of mitigating interference in impulse radio systems, see the patent application titled “Method for Mitigating Effects of Interference in Impulse Radio Communication,” application Ser. No. 09/587,033, filed Jun. 2, 1999, assigned to the assignee of the present invention, and incorporated herein by reference.

Moderating Interference in Equipment Control Applications

Yet another improvement to impulse radio includes moderating interference with impulse radio wireless control of an appliance. The control is affected by a controller remote from the appliance which transmits impulse radio digital control signals to the appliance. The control signals have a transmission power and a data rate. The method comprises the steps of establishing a maximum acceptable noise value for a parameter relating to interfering signals and a frequency range for measuring the interfering signals, measuring the parameter for the interference signals within the frequency range, and effecting an alteration of transmission of the control signals when the parameter exceeds the maximum acceptable noise value.

For greater elaboration of moderating interference while effecting impulse radio wireless control of equipment, see patent application titled “Method and Apparatus for Moderating Interference While Effecting Impulse Radio Wireless Control of Equipment,” application Ser. No. 09/586,163, filed Jun. 2, 1999, and assigned to the assignee of the present invention, and incorporated herein by reference.

Exemplary Transceiver Implementation

Transmitter

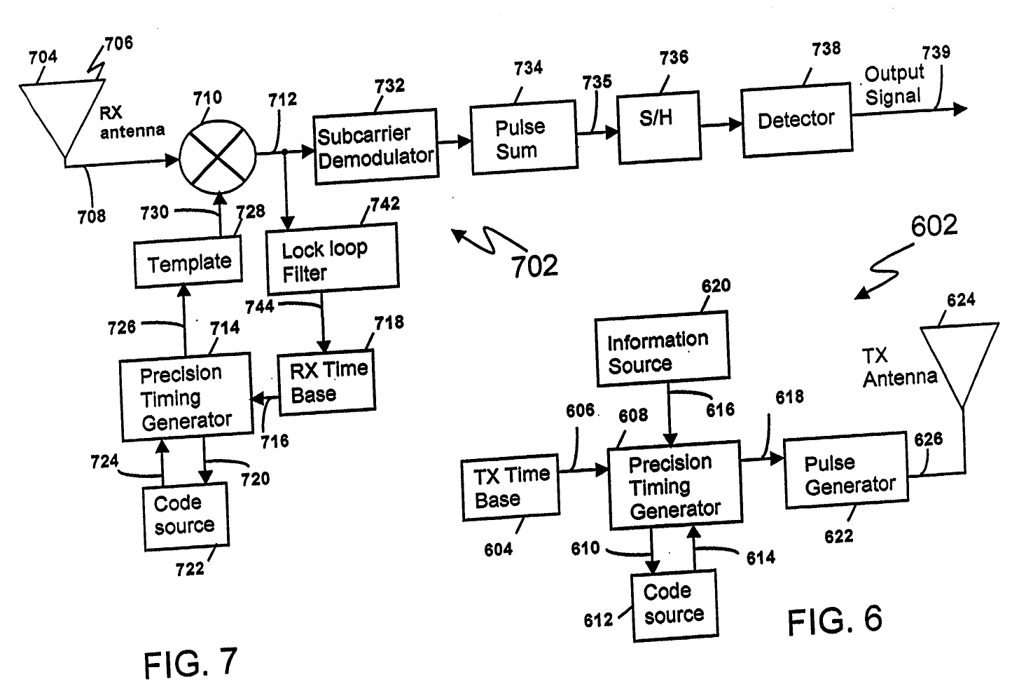

An exemplary embodiment of an impulse radio transmitter 602 of an impulse radio communication system having an optional subcarrier channel will now be described with reference to FIG. 6.

The transmitter 602 comprises a time base 604 that generates a periodic timing signal 606. The time base 604 typically comprises a voltage controlled oscillator (VCO), or the like, having a high timing accuracy and low jitter, on the order of picoseconds (ps). The control voltage to adjust the VCO center frequency is set at calibration to the desired center frequency used to define the transmitter's nominal pulse repetition rate. The periodic timing signal 606 is supplied to a precision timing generator 608.

The precision timing generator 608 supplies synchronizing signals 610 to the code source 612 and utilizes the code source output 614, together with an optional, internally generated subcarrier signal, and an information signal 616, to generate a modulated, coded timing signal 618.

An information source 620 supplies the information signal 616 to the precision timing generator 608. The information signal 616 can be any type of intelligence, including digital bits representing voice, data, imagery, or the like, analog signals, or complex signals.

A pulse generator 622 uses the modulated, coded timing signal 618 as a trigger signal to generate output pulses. The output pulses are provided to a transmit antenna 624 via a transmission line 626 coupled thereto. The output pulses are converted into propagating electromagnetic pulses by the transmit antenna 624. The electromagnetic pulses are called the emitted signal, and propagate to an impulse radio receiver 702, such as shown in FIG. 7, through a propagation medium. In a preferred embodiment, the emitted signal is wide-band or ultrawide-band, approaching a monocycle pulse as in FIG. 1B. However, the emitted signal may be spectrally modified by filtering of the pulses, which may cause them to have more zero crossings (more cycles) in the time domain, requiring the radio receiver to use a similar waveform as the template signal for efficient conversion.

Receiver

An exemplary embodiment of an impulse radio receiver (hereinafter called the receiver) for the impulse radio communication system is now described with reference to FIG. 7.

The receiver 702 comprises a receive antenna 704 for receiving a propagated impulse radio signal 706. A received signal 708 is input to a cross correlator or sampler 710, via a receiver transmission line, coupled to the receive antenna 704. The cross correlation 710 produces a baseband output 712.

The receiver 702 also includes a precision timing generator 714, which receives a periodic timing signal 716 from a receiver time base 718. This time base 718 may be adjustable and controllable in time, frequency, or phase, as required by the lock loop in order to lock on the received signal 708. The precision timing generator 714 provides synchronizing signals 720 to the code source 722 and receives a code control signal 724 from the code source 722. The precision timing generator 714 utilizes the periodic timing signal 716 and code control signal 724 to produce a coded timing signal 726. The template generator 728 is triggered by this coded timing signal 726 and produces a train of template signal pulses 730 ideally having waveforms substantially equivalent to each pulse of the received signal 708. The code for receiving a given signal is the same code utilized by the originating transmitter to generate the propagated signal. Thus, the timing of the template pulse train matches the timing of the received signal pulse train, allowing the received signal 708 to be synchronously sampled in the correlator 710. The correlator 710 preferably comprises a multiplier followed by a short term integrator to sum the multiplier product over the pulse interval.

The output of the correlator 710 is coupled to a subcarrier demodulator 732, which demodulates the subcarrier information signal from the optional subcarrier. The purpose of the optional subcarrier process, when used, is to move the information signal away from DC (zero frequency) to improve immunity to low frequency noise and offsets. The output of the subcarrier demodulator is then filtered or integrated in the pulse summation stage 734. A digital system embodiment is shown in FIG. 7. In this digital system, a sample and hold 736 samples the output 735 of the pulse summation stage 734 synchronously with the completion of the summation of a digital bit or symbol. The output of sample and hold 736 is then compared with a nominal zero (or reference) signal output in a detector stage 738 to provide an output signal 739 representing the digital state of the output voltage of sample and hold 736.

The baseband signal 712 is also input to a lowpass filter 742 (also referred to as lock loop filter 742). A control loop comprising the lowpass filter 742, time base 718, precision timing generator 714, template generator 728, and correlator 710 is used to generate an error signal 744. The error signal 744 provides adjustments to the adjustable time base 718 to position in time the periodic timing signal 726 in relation to the position of the received signal 708.

In a transceiver embodiment, substantial economy can be achieved by sharing part or all of several of the functions of the transmitter 602 and receiver 702. Some of these include the time base 718, precision timing generator 714, code source 722, antenna 704, and the like.

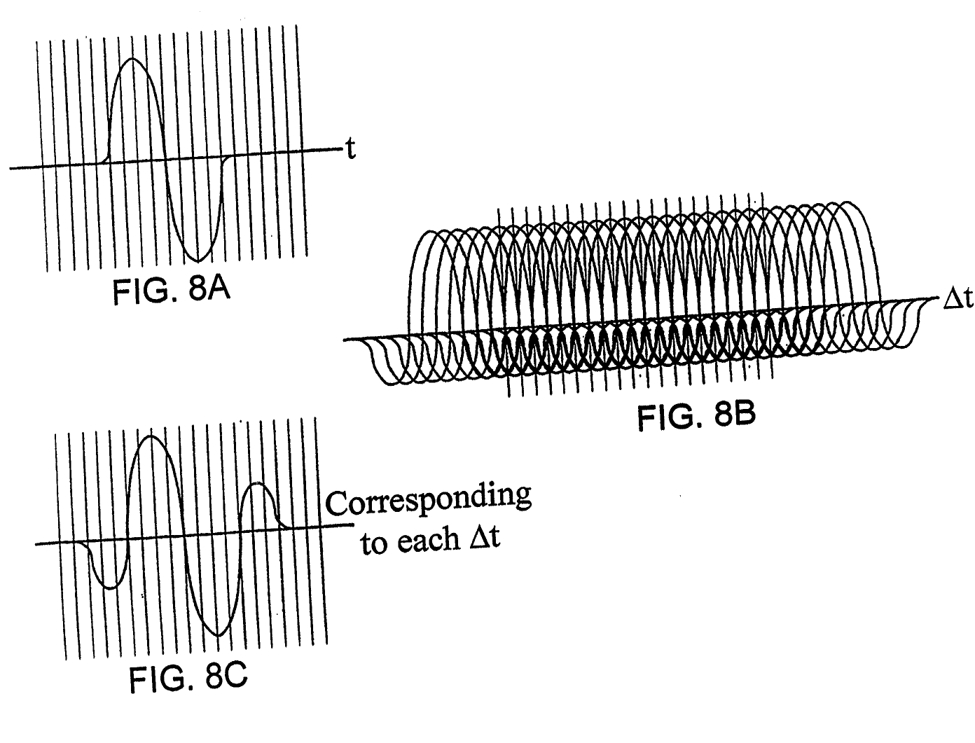

FIGS. 8A-8C illustrate the cross correlation process and the correlation function. FIG. 8A shows the waveform of a template signal. FIG. 8B shows the waveform of a received impulse radio signal at a set of several possible time offsets. FIG. 8C represents the output of the cross correlator for each of the time offsets of FIG. 8B. For any given pulse received, there is a corresponding point that is applicable on this graph. This is the point corresponding to the time offset of the template signal used to receive that pulse. Further examples and details of precision timing can be found described in U.S. Pat. No. 5,677,927, and commonly owned co-pending application application Ser. No. 09/146,524, filed Sep. 3, 1998, titled “Precision Timing Generator System and Method,” both of which are incorporated herein by reference.

Because of the unique nature of impulse radio receivers, several modifications have been recently made to enhance system capabilities. Modifications include the utilization of multiple correlators to measure the impulse response of a channel to the maximum communications range of the system and to capture information on data symbol statistics. Further, multiple correlators enable rake pulse correlation techniques, more efficient acquisition and tracking implementations, various modulation schemes, and collection of time-calibrated pictures of received waveforms. For greater elaboration of multiple correlator techniques, see patent application titled “System and Method of using Multiple Correlator Receivers in an Impulse Radio System”, application Ser. No. 09/537,264, filed Mar. 29, 2000, assigned to the assignee of the present invention, and incorporated herein by reference.

Methods to improve the speed at which a receiver can acquire and lock onto an incoming impulse radio signal have been developed. In one approach, a receiver includes an adjustable time base to output a sliding periodic timing signal having an adjustable repetition rate and a decode timing modulator to output a decode signal in response to the periodic timing signal. The impulse radio signal is cross-correlated with the decode signal to output a baseband signal. The receiver integrates T samples of the baseband signal and a threshold detector uses the integration results to detect channel coincidence. A receiver controller stops sliding the time base when channel coincidence is detected. A counter and extra count logic, coupled to the controller, are configured to increment or decrement the address counter by one or more extra counts after each T pulses is reached in order to shift the code modulo for proper phase alignment of the periodic timing signal and the received impulse radio signal. This method is described in more detail in U.S. Pat. No. 5,832,035 to Fullerton, incorporated herein by reference.

In another approach, a receiver obtains a template pulse train and a received impulse radio signal. The receiver compares the template pulse train and the received impulse radio signal. The system performs a threshold check on the comparison result. If the comparison result passes the threshold check, the system locks on the received impulse radio signal. The system may also perform a quick check, a synchronization check, and/or a command check of the impulse radio signal. For greater elaboration of this approach, see the patent application titled “Method and System for Fast Acquisition of Ultra Wideband Signals,” application Ser. No. 09/538,292, filed Mar. 29, 2000, assigned to the assignee of the present invention, and incorporated herein by reference.

A receiver has been developed that includes a baseband signal converter device and combines multiple converter circuits and an RF amplifier in a single integrated circuit package. For greater elaboration of this receiver, see the patent application titled “Baseband Signal Converter for a Wideband Impulse Radio Receiver,” application Ser. No. 09/356,384, filed Jul. 16, 1999, assigned to the assignee of the present invention, and incorporated herein by reference.

### PREFERRED EMBODIMENTS OF THE PRESENT INVENTION

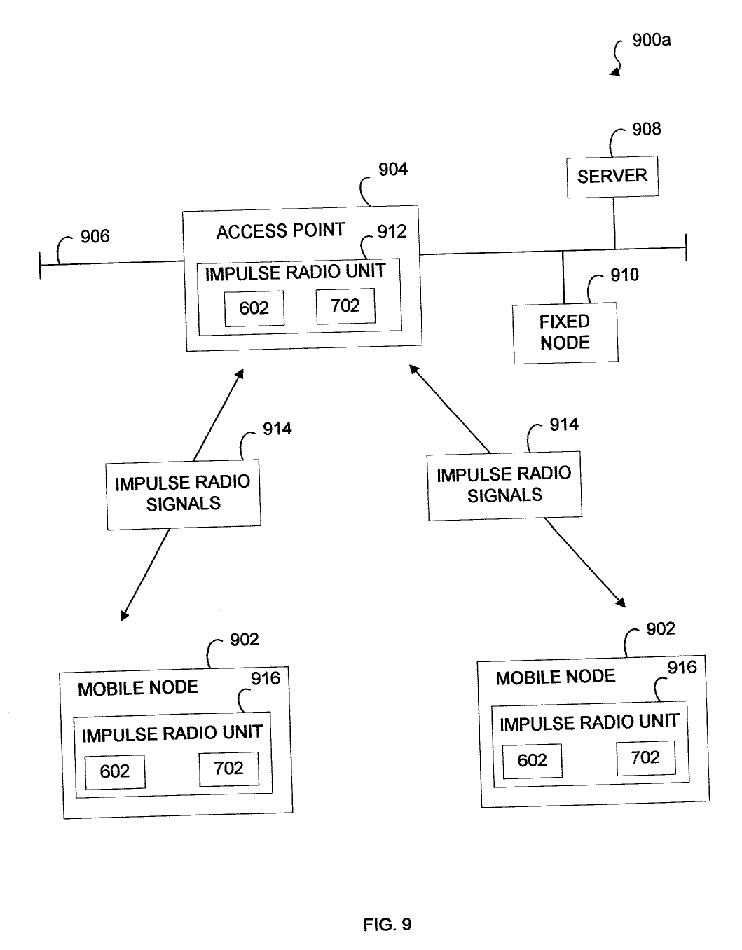

Referring to FIGS. 9-23, there are disclosed several embodiments of an exemplary wireless network 900a and 900b, an exemplary mobile node 902 and a preferred method 1100 in accordance with the present invention.

Although the present invention is described as using impulse radio technology, it should be understood that the present invention can be used with any type of ultra wideband technology, but is especially suited for use with time-modulated ultra wideband technology. Accordingly, the wireless network 900a and 900b, the mobile node 902 and the method 1100 should not be construed in a limited manner.

Referring to FIG. 9, there is a diagram illustrating the basic components of the wireless local area network 900a using the communication capabilities of impulse radio technology to improve communications between mobile nodes 902 and access points 904 in accordance with the present invention. In this embodiment, the network 900a includes one or more access points 904 (only one shown) each of which connect to a wired network 906 including, for example, a server 908 and a fixed node 910. A single access point 904 having a fixed location can support a group of mobile nodes 902 (only two shown) and can have a range of a few hundred meters (for example) in which to communicate with the mobile nodes 902.

Each assess point 904 includes a first impulse radio unit 912 that operates to transmit and receive impulse radio signals 914 to and from a second impulse radio unit 916 attached to each mobile node 902. The impulse radio signals 914 have a known pseudorandom sequence of pulses that look like a series of Gaussian waveforms that contain data (see FIGS. 1-3). Each impulse radio unit 912 and 916 can be configured as a transceiver and include a receiving impulse radio unit 602 and a transmitting impulse radio unit 702 (see FIGS. 6 and 7). In the alternative, the impulse radio units 912 and 916 can be configured as a receiver or transmitter depending on the functional requirements of the access point 904 and mobile node 902. For instance, the mobile node 902 may only need to download data and, as such, the first impulse radio unit 912 could be a transmitting impulse radio unit and the second impulse radio unit 916 would be a receiving impulse radio unit.

The access points 904 and mobile nodes 902 also include wireless LAN adapters that enable the physical characteristics of the impulse radio wireless link to become transparent to the operating systems of the wired network 906 and the mobile nodes 902. The mobile nodes 902 (including portable nodes) can be a variety of devices including, for example, laptop computers, desktop computers, personal digital assistants (PDAs), pen-based palmtop personal computers and printers.

Again, conventional radio technology used to transmit and receive standard radio signals within a building suffers from the adverse affects of “dead zones” and “multipath interference”. Dead zones in a building make it difficult for a traditional access point to maintain contact with a traditional mobile node using standard radio signals. In particular, the standard radio signals sent between the traditional mobile node and traditional access point may not be able to penetrate a certain wall or floor within the building and as such may not reach their destination. This is especially true if the traditional mobile node moves to different locations within the building. Fortunately in the present embodiment of the present invention, the impulse radio signals 914 transmitted between mobile nodes 902 and access points 904 are located very close to DC which makes the attenuation due to walls and floors minimal when compared to standard radio signals.

In addition, “multipath interference” which is very problematic within the closed structure of a building can be caused by the interference of a standard radio signal that has reached either the traditional mobile node or traditional access point by two or more paths. Essentially, a standard radio receiver may not be able to demodulate the standard radio signal because the transmitted radio signal effectively cancels itself out by bouncing of walls and floors of the building before reaching the standard radio receiver. The present invention is not affected by “multipath interference” because the impulses of the impulse radio signal 914 arriving from delayed multipath reflections typically arrive outside a correlation (or demodulation) period of the receiving impulse radio unit.

As described above, traditional wireless LANs use either standard radio signals or standard infrared electromagnetic waves to transfer data from a traditional mobile node to a traditional access point. However, these communication methods within traditional wireless LANs impose undesirable limits on range, data rate and communication quality. In particular, traditional wireless LANS have the following undesirable characteristics:

Ill-defined network boundaries with overlaps in coverage areas.

Suffer from limited spectral bandwidth.

Use a shared broadcast medium.

Lack full connectivity and are significantly less desirable than the wired physical layer.

Have dynamic topologies with mobility functions such as roaming and handoffs adding complexity.

Are essentially unprotected from outside signals.

In contrast, the use of impulse radio technology in the present invention provides many advantages over traditional wireless LAN technologies including, for example, the following:

Ultra-short duration pulses which yield ultrawide bandwidth signals.

Extremely low power spectral densities.

Excellent immunity to interference from other radio systems.

Consume substantially less power than conventional radios.

Capable of high bandwidth and multi-channel performance.

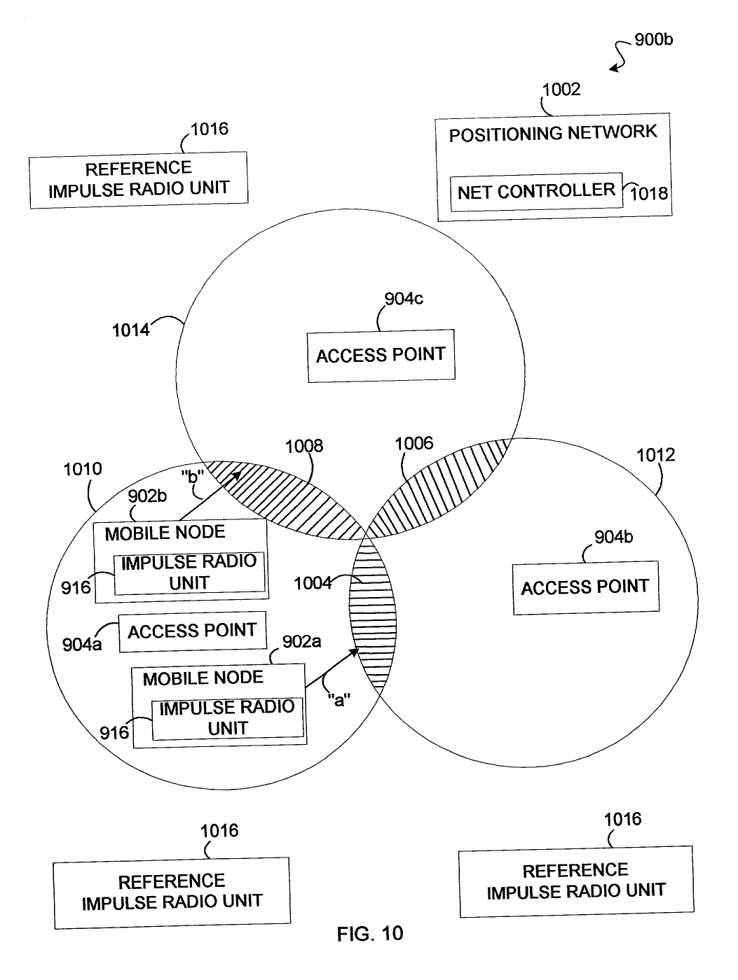

Referring to FIG. 10, there is a diagram illustrating the basic components of a wireless local area network 900b using the positioning and tracking capabilities of impulse radio technology to improve the communications and/or roaming scheme between mobile nodes 902 and access points 904 in accordance with the present invention. In this embodiment, the mobile nodes 902a 902b (only two shown) and access points 904a, 904b and 904c (only three shown) communicate with one another using traditional communication technology while the wireless LAN 900b uses the positioning and tracking capabilities of impulse radio technology to improve the roaming scheme. However, it should be understood that the mobile nodes 902a and 902b and access points 904a, 904b and 904c in this embodiment could also communicate with one another using impulse radio signals 914 as described above with respect to FIG. 9.

The wireless LAN 900b includes a positioning network 1002 connected to the wired network and capable of using impulse radio technology to periodically determine the position of the mobile node 902a and inform at least a first access point 904a (for example) which is servicing the mobile node 902a as to the current position of the mobile node 902a. The first access point 904a then informs the mobile node 902a when the determined position of the mobile node 902a is near or within an overlapped area 1004, 1006 and 1008 (e.g., overlapped area 1004) of at least two radio coverage areas 1010, 1012 and 1014 (e.g., coverage areas 1010 and 1012) managed by at least two access points 904a, 904b and 904c (e.g., access points 904a and 904b). Thereafter, the informed mobile node 902a having a wireless link with the first access point 904a has more lead time when compared to the traditional roaming scheme to interact with the second access point 904b (for example) before the mobile node 902a has to handoff communications to the second access point 904b (see travel path “a”)

In the traditional roaming scheme, a traditional mobile node monitors the signal-to-noise ratio (SNR) of its wireless communications as it moves and, if required, scans for available access points and then automatically connects to a desired access point to maintain continuous network access. Unfortunately, the traditional mobile node may move in a manner (e.g., too fast) that it can lose network connectivity before noticing that the SNR of the wireless communications has degraded below a minimum threshold and before being able to handoff communications to a new access point. Thus, it is an advantage of, the present invention, to notify the mobile node 902a when it is located near or within the overlapped area 1004 of radio coverage areas 1010 and 1012 managed access points 904a and 904b. This enables the mobile node 902 to have more time when compared to the traditional roaming scheme to interact with the second access point 904b before the mobile node 902a has to handoff communications to the second access point 904b. The additional time that the mobile node 902a has to interact with the second access point 904b may enable the mobile node 902a to handoff communications to the second access point 904b before experiencing a low SNR and losing network connectivity. For instance, the mobile node 902a can handoff communications to the second access point 904b after completion of a data transfer with the first access point 904a, after the mobile node 902a moves out of the radio coverage area of the first access point 904a or before the SNR of the wireless link between the mobile node 902a and the first access point 904a degrades below a predetermined threshold.

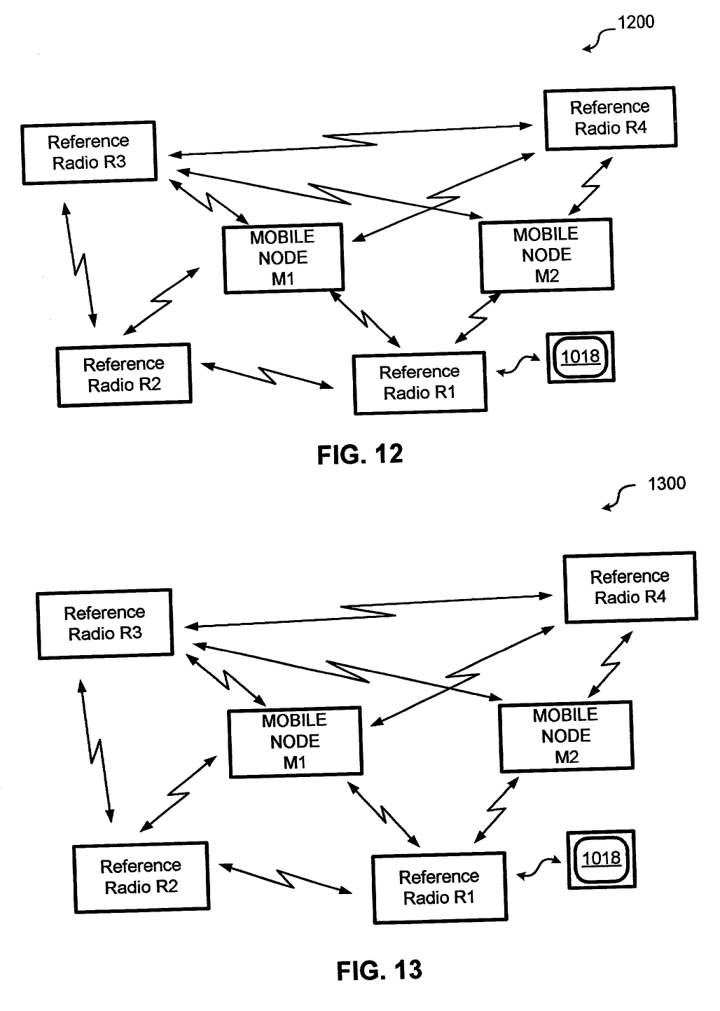

To enable the position of a mobile node 902a to be determined, the positioning network 1002 uses a series of reference impulse radio units 1016 (only 3 shown) and a net controller 1018. The reference impulse radio units 1016 have known positions and are located to provide maximum coverage throughout the building. Each mobile node 902a including an impulse radio unit 916 is capable of interacting with one or more of the reference impulse radio units 1016 such that either the mobile node 902a, the net controller 1018, or one of the reference impulse radio units 1016 is able to triangulate and calculate the current position of a mobile node 902a. A variety of impulse radio positioning networks that enable the present invention to perform the positioning and tracking functions are described in greater detail below with respect to FIGS. 12-23.

For instance, the positioning function of the positioning network 1002 can be accomplished by stepping through several steps. The first step is for the reference impulse radio units 1016 to synchronize together and begin passing information. Then, when a mobile node 902a enters a network area (e.g., area service by several reference impulse radio units 1016), it synchronizes itself to the previously synchronized reference impulse radio units 1016. Once the mobile node 902a is synchronized, it begins collecting and time-tagging range measurements from any available reference impulse radio units 1016. The mobile node 902a then takes these time-tagged ranges and, using a least squares-based or similar estimator, calculates its position within the network area. Finally, the mobile node 902a forwards its position calculation to the net controller 1018. Alternatively, one of the reference impulse radio units 1016 or the net controller 1018 can calculate the position of the mobile node 902a. In either case, at least one of the access points 904 has access to or is informed about the current position of mobile node 902a. Moreover, the net controller 1018 can be programmed to display the latest position of the mobile nodes 902a and 902b to building personnel.

It should also be understood that instead of using two or more reference impulse radio units 1016 to determine the current position of the mobile node 902a, one impulse radio unit can be used to determine the current position of the mobile node 902a. This can be accomplised by configuring the reference impulse radio unit 1016 to include an ultra-wideband antennae array that can be used to determine the position of the mobile node 902a by using return angle of arrival information.

In the event, the positioning network 1002 determines that the mobile node 902 is located in or near one of the overlapped areas 1004, 1006 and 1008, then the smart roaming capabilities of the present invention can make a decision to stay with one access point instead of constantly switching back-and-forth the connection from one access point to another access point. This feature of the present invention saves a lot of overhead to the WLAN caused by the switching back-and-forth between access points. In particular, the mobile node 902a (for example) would know which access point 904b (for example) it is moving towards and even the distance to the access point 904b which enables the mobile node 902a to make an intelligent decision on which access point 904b or 904a to associate with. For instance, the mobile node 902a is slowly moving towards access point 904b, so it disassociates with access point 904a and associates with access point 904b. If the mobile node 902a while moving slowly towards access point 904b measures a signal power/BER that is equal or less than the measured signal power/BER associated with access point 904a, but the position and motion vector indicates that the mobile node 902a is still moving towards access point 904b, then the mobile node 902a could decide that it is worth the higher BER for a short time period and not switch back to access point 904a. On the other hand, if the mobile node 902a was actually moving back towards access point 904a, then it could switch associations to access point 904a.

In the above example, the intelligence is in the mobile node 902a but the access point 904 could also have this intelligence or a combination of both. For instance, the mobile node 902a might be moving from access point 904a to access point 904b and finds that the signal power and BER are better with access point 904b. The mobile node 902a decides to associate with access point 904b, but the access point 904b knows that at the current distance the signal power and BER are not at standard levels (maybe a normal obstacle is temporarily out of position which is allowing better propagation) so access point 904b tells mobile node 902a to wait until it gets to distant X from the access point 904b before trying to associate with access point 904b. In addition to periodically determining the position of the mobile nodes 902a and 902b, the positioning network 1002 can also use a vectoring operation to track a mobile node 902b and determine which coverage area 1010, 1012 and 1014 (e.g., coverage area 1014) managed by one access point 904a, 904b or 904c (e.g., third access point 904c) the mobile node 902b is heading towards (see travel path “b”). The mobile node 902b is then notified by the servicing access point 904a or 904b (e.g., first access point 904a) about the third access point 904c it is heading towards. This notification gives the mobile node 902b more time when compared to traditional roaming schemes to authenticate with and measure the SNR associated with third access point 904c before having to handoff communications to the third access point 904c. Again, traditional roaming schemes are based only on SNR measurements and not position/tracking determination and SNR measurements as in the present invention. Like above, the mobile node 902b can handoff communications to the third access point 904c after completion of a data transfer with the first access point 904a, after the mobile node 902b moves out of the radio coverage area of the first access point 904a or before the SNR of the wireless link between the mobile node 902b and the first access point 904a degrades below a predetermined threshold.

After determining which access point 904a, 904b or 904c (e.g., third access point 904c) the mobile node 902b is heading towards, the mobile node 902 can also be notified by the serving access point 904a, 904b or 904c about any areas having known interference thus giving the mobile node 902 time to stop or change the direction it is moving before entering the area having known interference. Or, the smart roaming capabilities of the present invention can ensure that a soft handover to a new access point occurs before entering the dead zone.

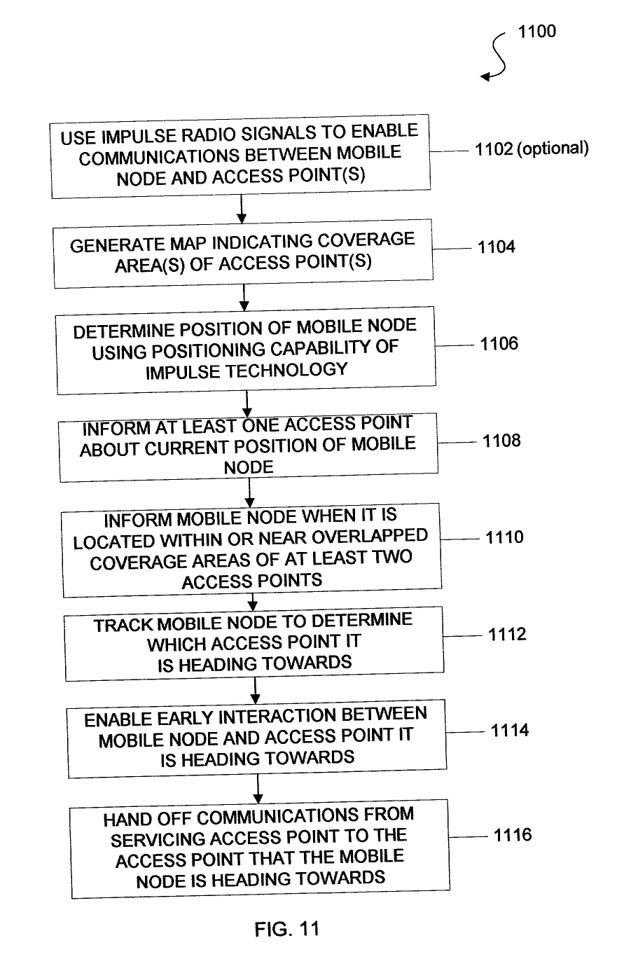

Referring to FIG. 11, there is a flowchart illustrating the basic steps of a preferred method 1100 for using impulse radio technology to improve the communications and/or a roaming scheme within a wireless network in accordance with the present invention. Beginning at step 1102 (optional), mobile nodes 902 and access points 904a, 904b and 904c can communicate with one another using impulse radio signals 914 (see FIG. 9). Alternatively, mobile nodes 902 and access points 904a, 904b and 904c can communicate with one another using traditional communication technology while the wireless LAN 900b uses the positioning and tracking capabilities of impulse radio technology to improve the roaming scheme as described in the steps below.

At step 1104, the net controller 1018 (or other component of the wireless LAN 900a and 900b) would generate a map indicating the coordinates of the radio coverage areas 1010, 1012 and 1012 of each access point 904a, 904b and 904c. The map may also indicate the layout of the building in which the wireless LAN 900a and 900b is located. The access points 904a, 904b and 904c would have access to the map.

At step 1106, the positioning network 1002 would use the positioning capabilities of impulse radio technology to periodically determine a position of each mobile node 902. In particular, each mobile node 902 is capable of interacting with one or more of the reference impulse radio units 1016 such that either the mobile node 902, the net controller 1018, or one of the reference impulse radio units 1016 is able to triangulate and calculate the current position of a mobile node 902.

At step 1108, the positioning network 1002 informs at least one access point 904a, 904b or 904c the wireless LAN 900a and 900b which is servicing the mobile node 902 as to the current position of the mobile node 902. Alternatively, each access point 904 can interact with the positioning network 1002 to obtain the current position of the mobile node 902.

At step 1110, the first access point 904a then informs the mobile node 902 when the determined position of the mobile node 902 is near or within an overlapped area 1004, 1006 and 1008 of at least two radio coverage areas 1010, 1012 and 1014 managed by at least two access points 904a, 904b and 904c. To accomplish this the service access point 904 would compare the current position of the mobile node 902 to the map generated in step 1104.

At step 1112, the positioning network 1002 can also use a vectoring operation to track the mobile node 902 and determine which coverage area 1010, 1012 and 1014 of two or more access points 904a, 904b and 904c the mobile node 902 is heading towards. The mobile node 902 is then notified by the serving access point 904a, 904b or 904c about the access point 904a, 904b or 904c it is heading towards. In addition, the mobile node 902 can be notified by the serving access point 904a, 904b or 904c about any areas having known interference thus giving the mobile node 902 time to stop or change the direction it is moving before entering the area having known interference.

At step 1114, the informed mobile node 902 now has more time when compared to traditional roaming schemes to authenticate with and measure the SNR associated with the access point 904a, 904b or 904c it is heading towards before having to handoff communications to that access point 904a, 904b or 904c.

At step 1116, the mobile node 902 can handoff communications to the new access point 904a, 904b or 904c after completion of a data transfer with the serving access point 904a, 904b or 904c, after the mobile node 902 moves out of the radio coverage area 1010, 1012 or 1014 of the serving access point 904a, 904b or 904c or before the SNR of the wireless link between the mobile node 902 and the serving access point 904a, 904b or 904c degrades below a predetermined threshold. The mobile node 902 operates to handoff communications to the new access point 904a, 904b or 904c if the SNR associated with that access point 904a, 904b or 904c is above a predetermined threshold.

The present invention can also require that a particular mobile node 902 be located in certain area(s) of a building in order to connect to the WLAN 900b. This feature can add additional security to the WLAN 900b based on the position of the mobile node 902. To accomplish this, the positioning network 1002 determines the position of a mobile node 902 when it is turned on and attempts to gain access to the WLAN 900b and then the positioning network 1002 will not allow the mobile node 902 to log in if the mobile node 902 is not located in an approved area of the building.

Impulse Radio Positioning Networks

A variety of impulse radio positioning networks capable of performing the positioning and tracking functions of the present invention are described in this Section (see also U.S. patent application Ser. No. 09/456,409). An impulse radio positioning network includes a set of reference impulse radio units 1016 (shown below as reference impulse radio units R1-R6), one or more mobile nodes 902 (shown below as mobile nodes M1-M3) and a net controller 1018. For clarity, the access points 904a, 904b and 904c and some other components of the wireless LANS 900a and 900b are not shown in FIGS. 12-23.

Synchronized Transceiver Tracking Architecture

Referring to FIG. 12, there is illustrated a block diagram of an impulse radio positioning network 1200 utilizing a synchronized transceiver tracking architecture. This architecture is perhaps the most generic of the impulse radio positioning networks since both mobile nodes M1 and M2 and reference impulse radio units R1-R4 are full two-way transceivers. The network 1200 is designed to be scalable, allowing from very few mobile nodes M1 and M2 and reference impulse radio units R1-R4 to a very large number.

This particular example of the synchronized transceiver tracking architecture shows a network 1200 of four reference impulse radio units R1-R4 and two mobile nodes M1 and M2. The arrows between the radios represent two-way data and/or information links. A fully inter-connected network would have every radio continually communicating with every other radio, but this is not required and can be dependent upon the needs of the particular application.

Each radio is a two-way transceiver; thus each link between radios is two-way (duplex). Precise ranging information (the distance between two radios) is distributed around the network 1200 in such a way as to allow the mobile nodes M1 and M2 to determine their precise three-dimensional position within a local coordinate system. This position, along with other data or information traffic, can then be relayed from the mobile nodes M1 and M2 back to the reference master impulse radio unit R1, one of the other reference relay impulse radio units R2-R4 or the net controller 1018.

The radios used in this architecture are impulse radio two-way transceivers. The hardware of the reference impulse radio units R1-R4 and mobile nodes M1 and M2 is essentially the same. The firmware, however, varies slightly based on the functions each radio must perform. For example, the reference master impulse radio unit R1 directs the passing of information and is typically responsible for collecting all the data for external graphical display at the net controller 1018. The remaining reference relay impulse radio units R2-R4 contain a separate version of the firmware, the primary difference being the different parameters or information that each reference relay impulse radio unit R2-R4 must provide the network. Finally, the mobile nodes M1 and M2 have their own firmware version that calculates their position.

In FIG. 12, each radio link is a two-way link that allows for the passing of information, both data and/or information. The data-rates between each radio link is a function of several variables including the number of pulses integrated to get a single bit, the number of bits per data parameter, the length of any headers required in the messages, the range bin size, and the number of radios in the network.

By transmitting in assigned time slots and by carefully listening to the other radios transmit in their assigned transmit time slots, the entire group of radios within the network, both mobile nodes M1 and M2 and reference impulse radio units R1-R4, are able to synchronize themselves. The oscillators used on the impulse radio boards drift slowly in time, thus they may require continual monitoring and adjustment of synchronization. The accuracy of this synchronization process (timing) is dependent upon several factors including, for example, how often and how long each radio transmits.

The purpose of this impulse radio positioning network 1200 is to enable the tracking of the mobile nodes M1 and M2. Tracking is accomplished by stepping through several well-defined steps. The first step is for the reference impulse radio units R1-R4 to synchronize together and begin passing information. Then, when a mobile node M1 or M2 enters the network area, it synchronizes itself to the previously synchronized reference impulse radio units R1-R4. Once the mobile node M1 or M2 is synchronized, it begins collecting and time-tagging range measurements from any available reference impulse radio units R1-R4 (or other mobile node M1 or M2). The mobile node M1 or M2 then takes these time-tagged ranges and, using a least squares-based or similar estimator, calculates the position of the mobile node M1 or M2 in local coordinates. If the situation warrants and the conversion possible, the local coordinates can be converted to any one of the worldwide coordinates such as Earth Centered Inertial (ECI), Earth Centered Earth Fixed (ECEF), or J2000 (inertial coordinates fixed to year 2000). Finally, the mobile node M1 or M2 forwards its position calculation to the net controller 1018 for storage and real-time display.

Unsynchronized Transceiver Tracking Architecture

Referring to FIG. 13, there is illustrated a block diagram of an impulse radio positioning network 1300 utilizing an unsynchronized transceiver tracking architecture. This architecture is similar to synchronized transceiver tracking of FIG. 12, except that the reference impulse radio units R1-R4 are not time-synchronized. Both the mobile nodes M1 and M2 and reference impulse radio units R1-R4 for this architecture are full two-way transceivers. The network is designed to be scalable, allowing from very few mobile nodes M1 and M2 and reference impulse radio units R1-R4 and to a very large number.

This particular example of the unsynchronized transceiver tracking architecture shows a network 1300 of four reference impulse radio units R1-R4 and two mobile nodes M1 and M2. The arrows between the radios represent two-way data and/or information links. A fully inter-connected network would have every radio continually communicating with every other radio, but this is not required and can be defined as to the needs of the particular application.

Each radio is a two-way transceiver; thus each link between radios is two-way (duplex). Precise ranging information (the distance between two radios) is distributed around the network in such a way as to allow the mobile nodes M1 and M2 to determine their precise three-dimensional position within a local coordinate system. This position, along with other data or information traffic, can then be relayed from the mobile nodes M1 and M2 back to the reference master impulse radio unit R1, one of the other reference relay impulse radio units R2-R3 or the net controller 1018.

The radios used in the architecture of FIG. 13 are impulse radio two-way transceivers. The hardware of the reference impulse radio units R1-R4 and mobile nodes M1 and M2 is essentially the same. The firmware, however, varies slightly based on the functions each radio must perform. For example, the reference master impulse radio unit R1 directs the passing of information, and typically is responsible for collecting all the data for external graphical display at the net controller 1018. The remaining reference relay impulse radio units R2-R4 contain a separate version of the firmware, the primary difference being the different parameters or information that each reference relay radio must provide the network. Finally, the mobile nodes M1 and M2 have their own firmware version that calculates their position and displays it locally if desired.

In FIG. 13, each radio link is a two-way link that allows for the passing of information, data and/or information. The data-rates between each radio link is a function of several variables including the number of pulses integrated to get a single bit, the number of bits per data parameter, the length of any headers required in the messages, the range bin size, and the number of radios in the network.

Unlike the radios in the synchronized transceiver tracking architecture, the reference impulse radio units R1-R4 in this architecture are not time-synchronized as a network. These reference impulse radio units R1-R4 operate independently (free-running) and provide ranges to the mobile nodes M1 and M2 either periodically, randomly, or when tasked. Depending upon the application and situation, the reference impulse radio units R1-R4 may or may not talk to other reference radios in the network.

As with the architecture of FIG. 12, the purpose of this impulse radio positioning network 1300 is to enable the tracking of mobile nodes M1 and M2. Tracking is accomplished by stepping through several steps. These steps are dependent upon the way in which the reference impulse radio units R1-R4 range with the mobile nodes M1 and M2 (periodically, randomly, or when tasked). When a mobile node M1 or M2 enters the network area, it either listens for reference impulse radio units R1-R4 to broadcast, then responds, or it queries (tasks) the desired reference impulse radio units R1-R4 to respond. The mobile node M1 or M2 begins collecting and time-tagging range measurements from reference (or other mobile) radios. The mobile node M1 or M2 then takes these time-tagged ranges and, using a least squares-based or similar estimator, calculates the position of the mobile node M1 or M2 in local coordinates. If the situation warrants and the conversion possible, the local coordinates can be converted to any one of the worldwide coordinates such as Earth Centered Inertial (ECI), Earth Centered Earth Fixed (ECEF), or J2000 (inertial coordinates fixed to year 2000). Finally, the mobile node M1 or M2 forwards its position calculation to the net controller 1018 for storage and real-time display.

Synchronized Transmitter Tracking Architecture

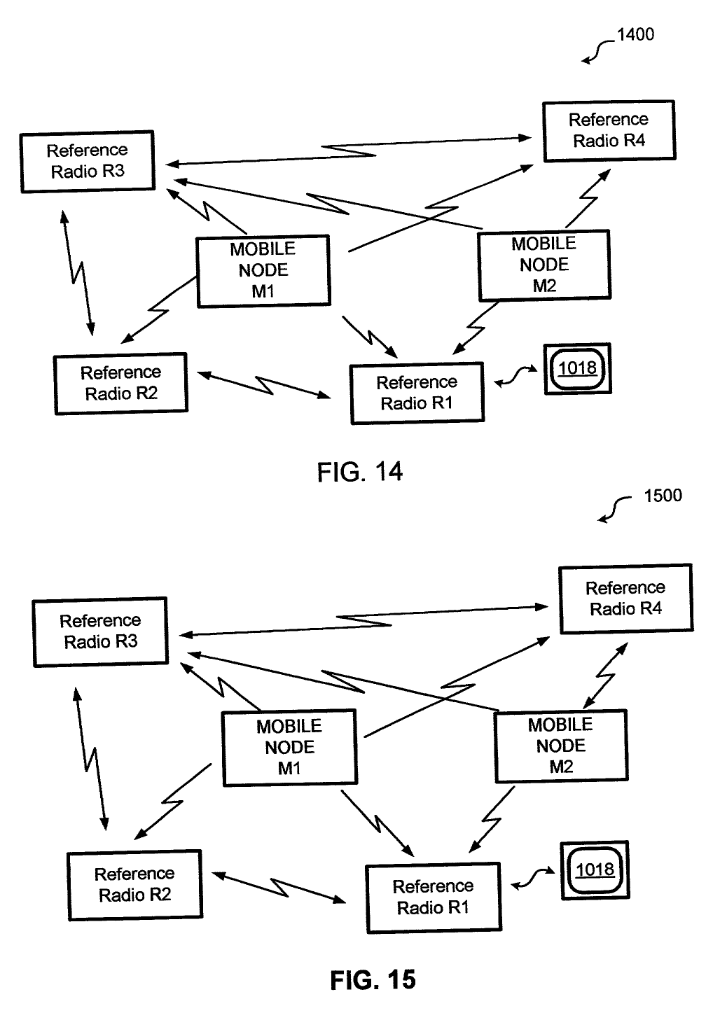

Referring to FIG. 14, there is illustrated a block diagram of an impulse radio positioning network 1400 utilizing a synchronized transmitter tracking architecture. This architecture is perhaps the simplest of the impulse radio positioning architectures, from the point-of-view of the mobile nodes M1 and M2, since the mobile nodes M1 and M2 simply transmit in a free-running sense. The network is designed to be scalable, allowing from very few mobile nodes M1 and M2 and reference impulse radio units R1-R4 to a very large number. This architecture is especially applicable to an “RF tag” (radio frequency tag) type of application.

This particular example of synchronized transmitter tracking architecture shows a network 1400 of four reference impulse radio units radios R1-R4 and two mobile nodes M1 and M2. The arrows between the radios represent two-way and one-way data and/or information links. Notice that the mobile nodes M1 and M2 only transmit, thus they do not receive the transmissions from the other radios.

Each reference impulse radio unit R1-R4 is a two-way transceiver; thus each link between reference impulse radio units R1-R4 is two-way (duplex). Precise ranging information (the distance between two radios) is distributed around the network in such a way as to allow the synchronized reference impulse radio units R1-R4 to receive transmissions from the mobile nodes M1 and M2 and then determine the three-dimensional position of the mobile nodes M1 and M2. This position, along with other data or information traffic, can then be relayed from reference relay impulse radio units R2-R4 back to the reference master impulse radio unit R1 or the net controller 1018.

The reference impulse radio units R1-R4 used in this architecture are impulse radio two-way transceivers, the mobile nodes M1 and M2 are one-way transmitters. The firmware in the radios varies slightly based on the functions each radio must perform. For example, the reference master impulse radio unit R1 is designated to direct the passing of information, and typically is responsible for collecting all the data for external graphical display at the net controller 1018. The remaining reference relay impulse radio units R2-R4 contain a separate version of the firmware, the primary difference being the different parameters or information that each reference relay impulse radio unit R2-R4 must provide the network. Finally, the mobile nodes M1 and M2 have their own firmware version that transmits pulses in predetermined sequences.

Each reference radio link is a two-way link that allows for the passing of information, data and/or information. The data-rates between each radio link is a function of several variables including the number of pulses integrated to get a single bit, the number of bits per data parameter, the length of any headers required in the messages, the range bin size, and the number of radios in the network.

By transmitting in assigned time slots and by carefully listening to the other radios transmit in their assigned transmit time slots, the entire group of reference impulse radio units R1-R4 within the network are able to synchronize themselves. The oscillators used on the impulse radio boards drift slowly in time, thus they may require monitoring and adjustment to maintain synchronization. The accuracy of this synchronization process (timing) is dependent upon several factors including, for example, how often and how long each radio transmits along with other factors. The mobile nodes M1 and M2, since they are transmit-only transmitters, are not time-synchronized to the synchronized reference impulse radio units R1-R4.

The purpose of the impulse radio positioning network is to enable the tracking of mobile nodes M1 and M2. Tracking is accomplished by stepping through several well-defined steps.

The first step is for the reference impulse radio units R1-R4 to synchronize together and begin passing information. Then, when a mobile node M1 or M2 enters the network area and begins to transmit pulses, the reference impulse radio units R1-R4 pick up these pulses as time-of-arrivals (TOAs). Multiple TOAs collected by different synchronized reference impulse radio units R1-R4 are then converted to ranges, which are then used to calculate the XYZ position of the mobile node M1 or M2 in local coordinates. If the situation warrants and the conversion possible, the local coordinates can be converted to any one of the worldwide coordinates such as Earth Centered Inertial (ECI), Earth Centered Earth Fixed (ECEF), or J2000 (inertial coordinates fixed to year 2000). Finally, the reference impulse radio units R1-R4 forwards their position calculation to the net controller 1018 for storage and real-time display.

Unsynchronized Transmitter Tracking Architecture

Referring to FIG. 15, there is illustrated a block diagram of an impulse radio positioning network 1500 utilizing an unsynchronized transmitter tracking architecture. This architecture is very similar to the synchronized transmitter tracking architecture except that the reference impulse radio units R1-R4 are not synchronized in time. In other words, both the reference impulse radio units R1-R4 and the mobile nodes M1 and M2 are free-running. The network is designed to be scalable, allowing from very few mobile nodes M1 and M2 and reference impulse radio units R1-R4 to a very large number. This architecture is especially applicable to an “RF tag” (radio frequency tag) type of application.

This particular example of the unsynchronized transmitter tracking architecture shows a network 1500 of four reference impulse radio units R1-R4 and two mobile nodes M1 and M2. The arrows between the radios represent two-way and one-way data and/or information links. Notice that the mobile nodes M1 and M2 only transmit, thus they do not receive the transmissions from the other radios. Unlike the synchronous transmitter tracking architecture, the reference impulse radio units R1-R4 in this architecture are free-running (unsynchronized). There are several ways to implement this design, the most common involves relaying the time-of-arrival (TOA) pulses from the mobile nodes M1 and M2 and reference impulse radio units R1-R4, as received at the reference impulse radio units R1-R4, back to the reference master impulse radio unit R1 which communicates with the net controller 1018.

Each reference impulse radio unit R1-R4 in this architecture is a two-way impulse radio transceiver; thus each link between reference impulse radio unit R1-R4 can be either two-way (duplex) or one-way (simplex). TOA information is typically transmitted from the reference impulse radio units R1-R4 back to the reference master impulse radio unit R1 where the TOAs are converted to ranges and then an XYZ position of the mobile node M1 or M2, which can then be forwarded and displayed at the net controller 1018.

The reference impulse radio units R1-R4 used in this architecture are impulse radio two-way transceivers, the mobile nodes M1 and M2 are one-way impulse radio transmitters. The firmware in the radios varies slightly based on the functions each radio must perform. For example, the reference master impulse radio R1 collects the TOA information, and is typically responsible for forwarding this tracking data to the net controller 1018. The remaining reference relay impulse radio units R2-R4 contain a separate version of the firmware, the primary difference being the different parameters or information that each reference relay impulse radio units R2-R4 must provide the network. Finally, the mobile nodes M1 and M2 have their own firmware version that transmits pulses in predetermined sequences.

Each reference radio link is a two-way link that allows for the passing of information, data and/or information. The data-rates between each radio link is a function of several variables including the number of pulses integrated to get a single bit, the number of bits per data parameter, the length of any headers required in the messages, the range bin size, and the number of radios in the network.

Since the reference impulse radio units R1-R4 and mobile nodes M1 and M2 are free-running, synchronization is actually done by the reference master impulse radio unit R1. The oscillators used in the impulse radios drift slowly in time, thus they may require monitoring and adjustment to maintain synchronization at the reference master impulse radio unit R1. The accuracy of this synchronization (timing) is dependent upon several factors including, for example, how often and how long each radio transmits along with other factors.

The purpose of the impulse radio positioning network is to enable the tracking of mobile nodes M1 and M2. Tracking is accomplished by stepping through several steps. The most likely method is to have each reference impulse radio unit R1-R4 periodically (randomly) transmit a pulse sequence. Then, when a mobile node M1 or M2 enters the network area and begins to transmit pulses, the reference impulse radio units R1-R4 pick up these pulses as time-of-arrivals (TOAs) as well as the pulses (TOAs) transmitted by the other reference radios. TOAs can then either be relayed back to the reference master impulse radio unit R1 or just collected directly (assuming it can pick up all the transmissions). The reference master impulse radio unit R1 then converts these TOAs to ranges, which are then used to calculate the XYZ position of the mobile node M1 or M2. If the situation warrants and the conversion possible, the XYZ position can be converted to any one of the worldwide coordinates such as Earth Centered Inertial (ECI), Earth Centered Earth Fixed (ECEF), or J2000 (inertial coordinates fixed to year 2000). Finally, the reference master impulse radio unit R1 forwards its position calculation to the net controller 1018 for storage and real-time display.

Synchronized Receiver Tracking Architecture

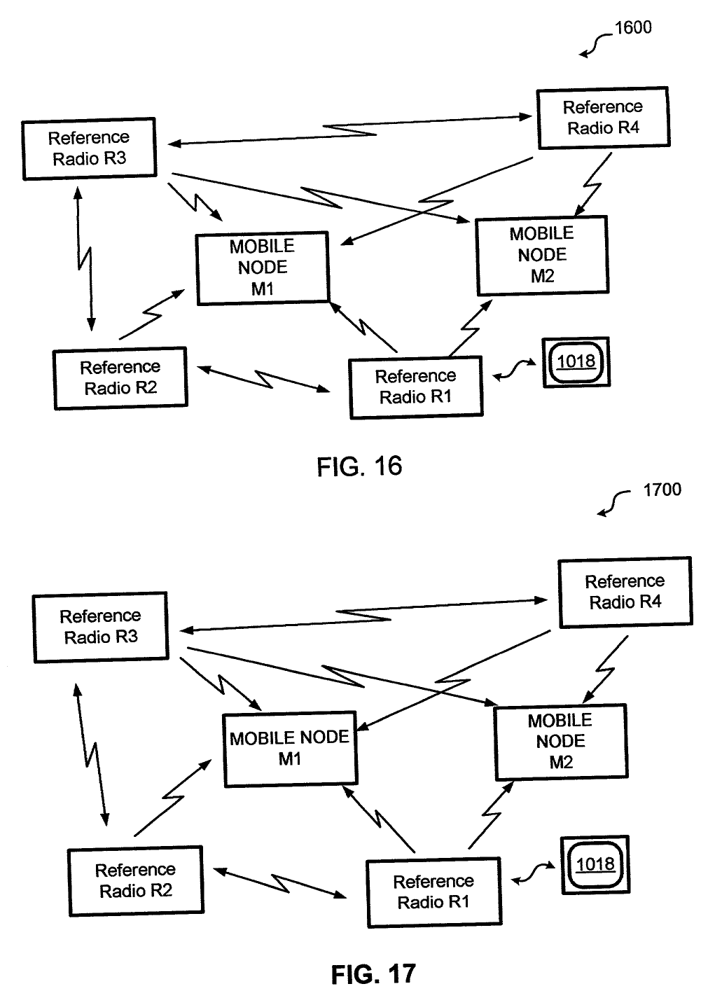

Referring to FIG. 16, there is illustrated a block diagram of an impulse radio positioning network 1600 utilizing a synchronized receiver tracking architecture. This architecture is different from the synchronized transmitter tracking architecture in that in this design the mobile nodes M1 and M2 determine their positions but are not able to broadcast it to anyone since they are receive-only radios. The network is designed to be scalable, allowing from very few mobile nodes M1 and M2 and reference impulse radio units R1-R4 to a very large number.

This particular example of the synchronized receiver tracking architecture shows a network 1600 of four reference impulse radio units R1-R4 and two mobile nodes M1 and M2. The arrows between the radios represent two-way and one-way data and/or information links. Notice that the mobile nodes M1 and M2 receive transmissions from other radios, and do not transmit.

Each reference impulse radio unit R1-R4 is a two-way transceiver, and each mobile node M1 and M2 is a receive-only radio. Precise, synchronized pulses are transmitted by the reference network and received by the reference impulse radio units R1-R4 and the mobile nodes M1 and M2. The mobile nodes M1 and M2 take these times-of-arrival (TOA) pulses, convert them to ranges, then determine their XYZ positions. Since the mobile nodes M1 and M2 do not transmit, only they themselves know their XYZ positions.

The reference impulse radio units R1-R4 used in this architecture are impulse radio two-way transceivers, the mobile nodes M1 and M2 are receive-only radios. The firmware for the radios varies slightly based on the functions each radio must perform. For example, the reference master impulse radio unit R1 is designated to direct the synchronization of the reference radio network. The remaining reference relay impulse radio units R2-R4 contain a separate version of the firmware, the primary difference being the different parameters or information that each reference relay impulse radio unit R2-R4 must provide the network. Finally, the mobile nodes M1 and M2 have their own firmware version that calculates their position and displays it locally if desired.

Each reference radio link is a two-way link that allows for the passing of information, data and/or information. The mobile nodes M1 and M2 are receive-only. The data-rates between each radio link is a function of several variables including the number of pulses integrated to get a single bit, the number of bits per data parameter, the length of any headers required in the messages, the range bin size, and the number of radios in the network.

By transmitting in assigned time slots and by carefully listening to the other reference impulse radio units R1-R4 transmit in their assigned transmit time slots, the entire group of reference impulse radio units R1-R4 within the network are able to synchronize themselves. The oscillators used on the impulse radio boards may drift slowly in time, thus they may require monitoring and adjustment to maintain synchronization. The accuracy of this synchronization (timing) is dependent upon several factors including, for example, how often and how long each radio transmits along with other factors.

The purpose of the impulse radio positioning network is to enable the tracking of mobile nodes M1 and M2. Tracking is accomplished by stepping through several well-defined steps. The first step is for the reference impulse radio units R1-R4 to synchronize together and begin passing information. Then, when a mobile node M1 or M2 enters the network area, it begins receiving the time-of-arrival (TOA) pulses from the reference radio network. These TOA pulses are converted to ranges, then the ranges are used to determine the XYZ position of the mobile node M1 or M2 in local coordinates using a least squares-based estimator. If the situation warrants and the conversion possible, the local coordinates can be converted to any one of the worldwide coordinates such as Earth Centered Inertial (ECI), Earth Centered Earth Fixed (ECEF), or J2000 (inertial coordinates fixed to year 2000).

Unsynchronized Receiver Tracking Architecture

Referring to FIG. 17, there is illustrated a block diagram of an impulse radio positioning network 1700 utilizing an unsynchronized receiver tracking architecture. This architecture is different from the synchronized receiver tracking architecture in that in this design the reference impulse radio units R1-R4 are not time-synchronized. Similar to the synchronized receiver tracking architecture, mobile nodes M1 and M2 determine their positions but cannot broadcast them to anyone since they are receive-only radios. The network is designed to be scalable, allowing from very few mobile nodes M1 and M2 and reference impulse radio units R1-R4 to a very large number.

This particular example of the unsynchronized receiver tracking architecture shows a network 1700 of four reference impulse radio units R1-R4 and two mobile nodes M1 and M2. The arrows between the radios represent two-way and one-way data and/or information links. Notice that the mobile nodes M1 and M2 only receive transmissions from other radios, and do not transmit.

Each reference impulse radio unit R1-R4 is an impulse radio two-way transceiver, each mobile node M1 and M2 is a receive-only impulse radio. Precise, unsynchronized pulses are transmitted by the reference network and received by the other reference impulse radio units R1-R4 and the mobile nodes M1 and M2. The mobile nodes M1 and M2 take these times-of-arrival (TOA) pulses, convert them to ranges, and then determine their XYZ positions. Since the mobile nodes M1 and M2 do not transmit, only they themselves know their XYZ positions.

The reference impulse radio units R1-R4 used in this architecture are impulse radio two-way transceivers, the mobile nodes M1 and M2 are receive-only radios. The firmware for the radios varies slightly based on the functions each radio must perform. For this design, the reference master impulse radio unit R1 may be used to provide some synchronization information to the mobile nodes M1 and M2. The mobile nodes M1 and M2 know the XYZ position for each reference impulse radio unit R1-R4 and as such they may do all of the synchronization internally.

The data-rates between each radio link is a function of several variables including the number of pulses integrated to get a single bit, the number of bits per data parameter, the length of any headers required in the messages, the range bin size, and the number of impulse radios in the network.

For this architecture, the reference impulse radio units R1-R4 transmit in a free-running (unsynchronized) manner. The oscillators used on the impulse radio boards often drift slowly in time, thus requiring monitoring and adjustment of synchronization by the reference master impulse radio unit R1 or the mobile nodes M1 and M2 (whomever is doing the synchronization). The accuracy of this synchronization (timing) is dependent upon several factors including, for example, how often and how long each radio transmits.

The purpose of the impulse radio positioning network is to enable the tracking mobile nodes M1 and M2. Tracking is accomplished by stepping through several steps. The first step is for the reference impulse radio units R1-R4 to begin transmitting pulses in a free-running (random) manner. Then, when a mobile node M1 or M2 enters the network area, it begins receiving the time-of-arrival (TOA) pulses from the reference radio network. These TOA pulses are converted to ranges, then the ranges are used to determine the XYZ position of the mobile node M1 or M2 in local coordinates using a least squares-based estimator. If the situation warrants and the conversion possible, the local coordinates can be converted to any one of the worldwide coordinates such as Earth Centered Inertial (ECI), Earth Centered Earth Fixed (ECEF), or J2000 (inertial coordinates fixed to year 2000).

Mixed Mode Tracking Architecture

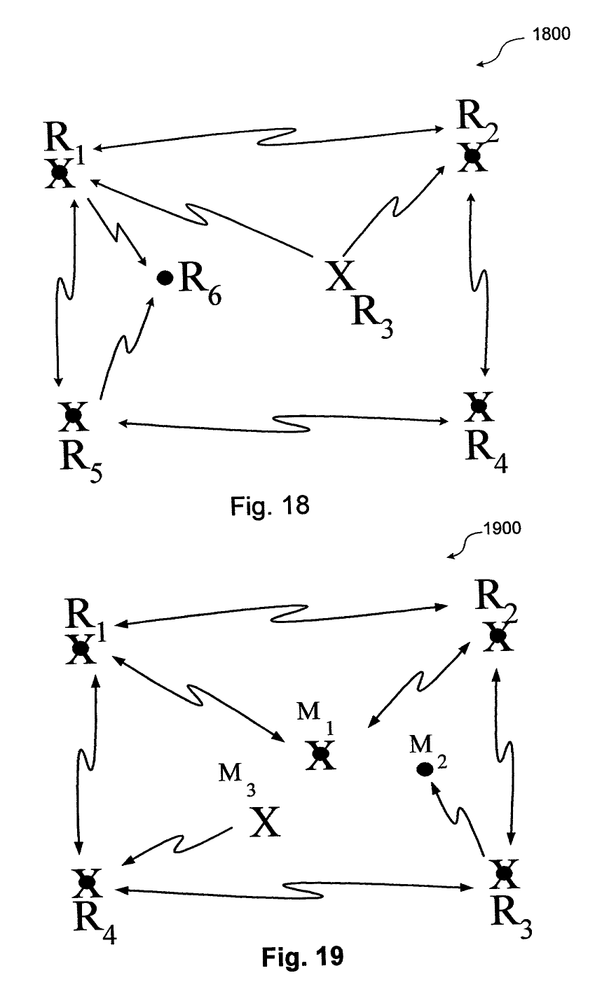

For ease of reference, in FIGS. 18-23 the below legend applies.

Symbols and Definitions

| | |
|---|---|
| [symbol] | Receiver Radio (receive only) |
| X | Transmitter Radio (transmit only) |
| [symbol] | Transceiver Radio (receive and transmit) |
| Rᵢ | Reference Radio (fixed location) |
| Mᵢ | Mobile Radio (radio being tracked) |
| [symbol] | Duplex Radio Link |
| [symbol] | Simplex Radio Link |

TOA, DTOA Time of Arrival, Differenced TOA

Referring to FIG. 18, there is illustrated a diagram of an impulse radio positioning network 1800 utilizing a mixed mode reference radio tracking architecture. This architecture defines a network of reference impulse radio units R1-R6 comprised of any combination of transceivers (R₁, R₂, R₄, R₅), transmitters (R₃), and receivers (R₆). Mobile nodes (none shown) entering this mixed-mode reference network use whatever reference radios are appropriate to determine their positions.

Referring to FIG. 19, there is a diagram of an impulse radio positioning network 1900 utilizing a mixed mode mobile apparatus tracking architecture. Herein, the mobile nodes M1-M3 are mixed mode and reference impulse radio units R1-R4 are likely time-synched. In this illustrative example, the mobile node M1 is a transceiver, mobile node M2 is a transmitter, and mobile node M3 is a receiver. The reference impulse radio units R1-R4 can interact with different types of mobile nodes M1-M3 to help in the determination of the positions of the mobile apparatuses.

Antennae Architectures

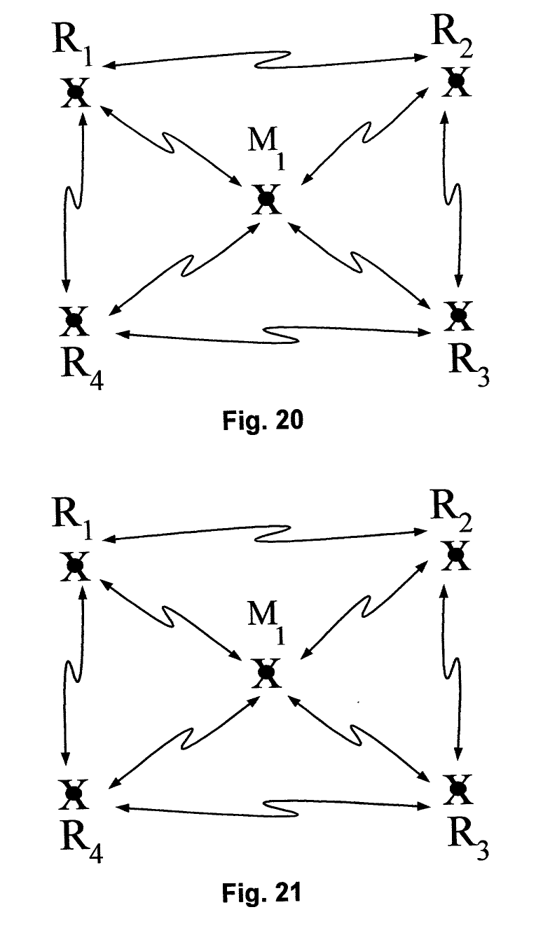

Referring to FIG. 20, there is illustrated a diagram of a steerable null antennae architecture capable of being used in an impulse radio positioning network. The aforementioned impulse radio positioning networks can implement and use steerable null antennae to help improve the impulse radio distance calculations. For instance, all of the reference impulse radio units R1-R4 or some of them can utilize steerable null antenna designs to direct the impulse propagation; with one important advantage being the possibility of using fewer reference impulse radio units or improving range and power requirements. The mobile node M1 can also incorporate and use a steerable null antenna.

Referring to FIG. 21, there is illustrated a diagram of a specialized difference antennae architecture capable of being used in an impulse radio positioning network. The reference impulse radio units R1-R4 of this architecture may use a difference antenna analogous to the phase difference antenna used in GPS carrier phase surveying. The reference impulse radio units R1-R4 should be time synched and the mobile node M1 should be able to transmit and receive.

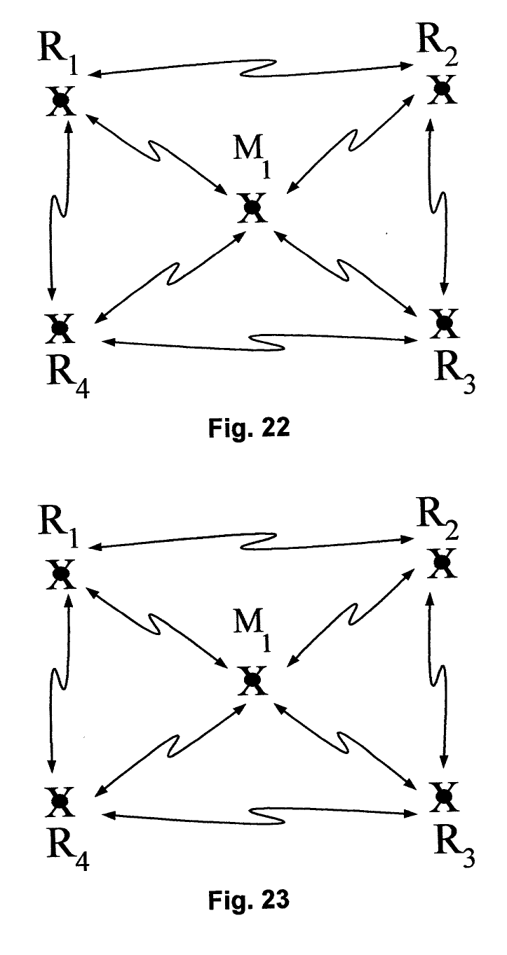

Referring to FIG. 22, there is illustrated a diagram of a specialized directional antennae architecture capable of being used in an impulse radio positioning network. As with the steerable null antennae design, the implementation of this architecture is often driven by design requirements. The reference impulse radio units R1-R4 and the mobile apparatus A1 can incorporate a directional antennae. In addition, the reference impulse radio units R1-R4 are likely time-synched.

Referring to FIG. 23, there is illustrated a diagram of an amplitude sensing architecture capable of being used in an impulse radio positioning network. Herein, the reference impulse radio units R1-R4 are likely time-synched. Instead of the mobile node M1 and reference impulse radio units R1-R2 measuring range using TOA methods (round-trip pulse intervals), signal amplitude is used to determine range. Several implementations can be used such as measuring the “absolute” amplitude and using a pre-defined look up table that relates range to “amplitude” amplitude, or “relative” amplitude where pulse amplitudes from separate radios are differenced. Again, it should be noted that in this, as all architectures, the number of radios is for illustrative purposes only and more than one mobile impulse radio can be implemented in the present architecture.

Although various embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

What is claimed is:

1. A wireless network comprising:
a mobile node; and
a plurality of access points each of which is capable of managing a radio coverage area and also capable of enabling an impulse radio wireless link with the mobile node.

2. The wireless network of claim 1, further comprising a positioning network capable of determining a position of the mobile node and also capable of informing at least a first access point about the determined position of the mobile node, wherein said mobile node interacting with the first access point can now have more lead time to interact with a second access point before said mobile node has to handoff communications to the second access point.

3. The wireless network of claim 2, wherein said positioning network further includes a net controller capable of determining the position of said mobile node by the interaction between said mobile node and at least two reference impulse radio units.

4. The wireless network of claim 2, wherein said positioning network is also capable of anticipating which access point of the plurality of access points the mobile node is heading towards by tracking the movement of the mobile node.

5. The wireless network of claim 1, wherein said wireless network is a wireless local area network.

6. The wireless network of claim 1, wherein said mobile node is a laptop computer or a personal digital assistant.

7. The wireless network of claim 1, wherein said mobile node can log into the wireless network only if the mobile node is located in an approved area.

8. A mobile node comprising:
an impulse radio unit capable of using impulse radio signals to interact with an access point.

9. The mobile node of claim 8, wherein said impulse radio units is further capable of interacting with a position network that determines a position of the impulse radio unit and forwards the determined position to a first access point that informs the mobile node when the determined position of the impulse radio unit is within an overlapped area of at least two radio coverage areas of at least two access points, wherein said informed mobile node having a wireless link with the first access point now has more lead time to interact with a second access point before said mobile node has to handoff communications to the second access point.

10. The mobile node of claim 9, wherein said positioning network further includes a net controller capable of determining the position of said impulse radio unit by the interaction between said impulse radio unit and at least two reference impulse radio units.

11. The mobile node of claim 9, wherein said positioning network is also capable of anticipating which access point of the at least two access points the impulse radio unit is heading towards by tracking the movement of the impulse radio unit.

12. The mobile node of claim 8, wherein said wireless link is an impulse radio wireless link.

13. The mobile node of claim 8, wherein said mobile node is a laptop computer.

14. The mobile node of claim 8, wherein said mobile node is a personal digital assistant.

15. A method for improving communications within a wireless network using impulse radio technology, said method comprising the step of:
using impulse radio signals to enable communications between a mobile node and an access point.

16. The method of claim 15, further comprising the steps of:
generating a map including coordinates of a radio coverage area of each access point within the wireless network;
determining a position of the mobile node;
informing the mobile node when the determined position of the mobile node is within an overlapped area of the radio coverage areas of at least two access points;
enabling the informed mobile node having a wireless link with a first access point to now have more lead time to interact with a second access point before said mobile node has to handoff communications to the second access point.

17. The method of claim 16, further comprising the step of tracking the movement of the mobile node so as to anticipate which access point of the at least two access points the mobile node is heading towards.

18. The method of claim 16, wherein said step of determining the position of the mobile node further includes using impulse radio technology to determine the position of the mobile node.

19. The method of claim 16, wherein said step of determining the position of the mobile node further includes enabling the interaction between the mobile node and at least two reference impulse radio units to determine the position of the mobile node.

20. A wireless network comprising:
a plurality of access points each of which is capable of managing a radio coverage area and also capable of enabling a wireless link with a mobile node; and
a positioning network capable of determining a position of the mobile node and also capable of informing at least a first access point about the determined position of the mobile node; and
said mobile node interacting with the first access point can now have more lead time to interact with a second access point before said mobile node has handoff communications to the second access point.

21. The wireless network of claim 20, wherein said positioning network further includes a net controller capable of determining the position of said mobile node by the interaction between said mobile node and at least two reference impulse radio units.

22. The wireless network of claim 20, wherein said positioning network is also capable anticipating which access point of the plurality of access points the mobile node is heading towards by tracking the movement of the mobile node.

23. The wireless network of claim 20, wherein said wireless link is an impulse radio wireless link.

24. The wireless network of claim 20, wherein said wireless network is a wireless local area network.

25. The wireless network of claim 20, wherein said mobile node is a laptop computer.

26. The wireless network of claim 20, wherein said mobile node is a personal digital assistant.

27. The wireless network of claim 20, wherein said mobile node would handoff communications to the second access point after completion of a data transfer.

28. The wireless network of claim 20, wherein said mobile node would handoff communications to the second access point after said mobile node moves out of the radio coverage area of the first access point.

29. The wireless network of claim 20, wherein said mobile node would handoff communications to the second access point before a signal quality of the wireless link between said mobile node and the first access point degrades below a predetermined threshold.

30. The wireless network of claim 20, wherein said first access point can alert said mobile node before said mobile node travels into an are a known to have interference.

31. A mobile node comprising:
an impulse radio unit capable of interacting with a position network that determines a position of the impulse radio unit and forwards the determined position to a first access point that informs the mobile node when the determined position of the impulse radio unit is within an overlapped area of at least two radio coverage areas of at least two access points, wherein said informed mobile node having a wireless link with the first access point now has more lead time to interact with a second access point before said mobile node has to handoff communications to the second access point.

32. The mobile node of claim 31, wherein said positioning network further includes a net controller capable of determining the position of said impulse radio unit by the interaction between said impulse radio unit and at least two reference impulse radio units.

33. The mobile node of claim 31, wherein said positioning network is also capable of anticipating which access point of the at least two access points the impulse radio unit is heading towards by tracking the movement of the impulse radio unit.

34. The mobile node of claim 31, wherein said wireless link is an impulse radio wireless link.

35. The mobile node of claim 31, wherein said wireless network is a wireless local area network.

36. The mobile node of claim 31, wherein said mobile node is a laptop computer.

37. The mobile node of claim 31, wherein said mobile node is a personal digital assistant.

38. The mobile node of claim 31, wherein said mobile node would handoff communications to the second access point after completion of a data transfer.

39. The mobile node of claim 31, wherein said mobile node would handoff communications to the second access point after said mobile node moves out of the radio coverage area of the first access point.

40. The mobile node of claim 31, wherein said mobile node would handoff communications to the second access point before a signal quality of the wireless link between said mobile node and the first access point degrades below a predetermined threshold.

41. The mobile node of claim 31, wherein said first access point can alert said mobile node before said mobile node travels into an area known to have interference.

42. A method for improving a roaming scheme within a wireless network using impulse radio technology, said method comprising the steps of:
generating a map including coordinates of a radio coverage of each access point within the wireless network;
determining a position of a mobile node;
informing the mobile node when the determined position of the mobile node is within an overlapped area of the radio coverage areas of at least two access points;
enabling the informed mobile node having a wireless link with a first access point to now have more lead time to interact with a second access point before said mobile node has to handoff communications to the second access point.

43. The method of claim 42, further comprising the step of tracking the movement of the mobile node so as to anticipate which access point of the at least two access points the mobile node is heading towards.

44. The method of claim 42, wherein said step of determining the position of the mobile node further includes using impulse radio technology to determine the position of the mobile node.

45. The method of claim 42, wherein said step of determining the position of the mobile node further includes enabling the interaction between the mobile node and at least two reference impulse radio units to determine the position of the mobile node.

46. The method of claim 42, wherein said wireless link is an impulse radio wireless link.

47. The method of claim 42, wherein said mobile node is a laptop computer.

48. The method of claim 42, wherein said mobile node is a personal digital assistant.

49. The method of claim 42, wherein said mobile node would handoff communications to the second access point after completion of a data transfer.

50. The method of claim 42, wherein said mobile node would handoff communications to the second access point after said mobile node moves out of the radio coverage area of the first access point.

51. The method of claim 42, wherein said mobile node would handoff communications to the second access point before a signal quality of the wireless link between said mobile node and the first access point degrades below a predetermined threshold.

52. The method of claim 42, wherein said first access point can alert said mobile node before said mobile node travels into an area known to have interference.
